(19) United States
(12) Patent Application Publication
(10) Pub. No.: US 2024/0167325 A1
(43) Pub. Date: May 23, 2024

(54) MULTIPLE PANE INSULATED GLAZING UNITS AND METHODS OF MANUFACTURE OF SAME

(71) Applicant: JELD-WEN, Inc., Charlotte, NC (US)

(72) Inventors: Yuxuan Gong, Lewis Center, OH (US); Jason Kantola, Klamath Falls, OR (US); Jason Dassel, Klamath Falls, OR (US); Paul Hemingfield, Charlotte, NC (US); Neal Hambleton, Huntersville, NC (US)

(73) Assignee: JELD-WEN, Inc., Charlotte, NC (US)

(21) Appl. No.: 18/058,550

(22) Filed: Nov. 23, 2022

(51) Int. Cl. E06B 3/663; E06B 3/67; E06B 3/673; E06B 3/677

(52) U.S. Cl. CPC E06B 3/66366; E06B 3/66314; E06B 3/66352; E06B 3/6715; E06B 3/67326; E06B 3/6736; E06B 3/6775; E06B 3/66361; E06B 2003/66395

(57) ABSTRACT

A multiple pane insulated glazing unit for a fenestration unit includes a first outer pane including a first thickness defined between a first outer surface and a first inner surface. A first spacer is coupled to the first inner surface. A second outer pane has a second thickness defined between a second outer surface and a second inner surface. A spacer is coupled to the second inner surface, and an intermediate pane is coupled to at least one of the first spacer and the spacer. The intermediate pane has a third thickness defined between a third inner surface and a fourth inner surface that is less than the first thickness and the second thickness. The third thickness is between about 0.2 millimeters (mm) to about 1.2 millimeters (mm), and the first outer pane, the second outer pane and the intermediate pane are composed of boron-free soda lime silicate glass.

### TECHNICAL FIELD

The present disclosure generally relates to insulated glazing units for fenestration units, and more particularly relates to a multiple pane insulated glazing unit for a fenestration unit and methods of manufacturing multiple pane insulated glazing units.

### BACKGROUND

A fenestration unit, such as a window, sliding window, slider door, etc., may include a frame that supports one or more other components of the unit. For example, the fenestration unit may include a frame that supports a sash, which in turn supports a glazing unit. The glazing unit enables light to pass through the fenestration unit, and may also permit thermal energy to pass through the fenestration unit. As the fenestration unit may be installed in a building or other structure, it is generally undesirable for thermal energy within the building or other structure to pass freely through the glazing unit as it reduces an energy efficiency of the building or other structure.

Accordingly, it is desirable to provide a multiple pane insulated glazing unit for use with a fenestration unit, which reduces an amount of thermal energy that passes through the multiple pane insulated glazing unit into the environment and methods for manufacturing the multiple pane insulated glazing units. Furthermore, other desirable features and characteristics of the present invention will become apparent from the subsequent detailed description and the appended claims, taken in conjunction with the accompanying drawings and the foregoing technical field and background.

### SUMMARY

According to various embodiments, provided is a multiple pane insulated glazing unit for a fenestration unit. The multiple pane insulated glazing unit includes a first outer pane including a first outer surface opposite a first inner surface. The first outer pane has a first thickness defined between the first outer surface and the first inner surface. The multiple pane insulated glazing unit includes a first spacer coupled to the first inner surface, and a second outer pane including a second outer surface opposite a second inner surface. The second outer pane has a second thickness defined between the second outer surface and the second inner surface. The multiple pane insulated glazing unit includes a spacer coupled to the second inner surface, and an intermediate pane coupled to at least one of the first spacer and the spacer so as to be disposed between the first outer pane and the second outer pane. The intermediate pane includes a third inner surface opposite a fourth inner surface, and the intermediate pane has a third thickness defined between the third inner surface and the fourth inner surface that is less than the first thickness and the second thickness. The third thickness is between about 0.2 millimeters (mm) to about 1.2 millimeters (mm), and the first outer pane, the second outer pane and the intermediate pane are composed of boron-free soda lime silicate glass.

The first thickness and the second thickness are about the same. The intermediate pane comprises a single intermediate pane having the third inner surface and the fourth inner surface, and the third inner surface is coupled to the first spacer and the fourth inner surface is coupled to the spacer. A first chamber is defined between the first inner surface and the third inner surface, a second chamber is defined between the fourth inner surface and the second inner surface, the first spacer encloses the first chamber, and the spacer encloses the second chamber. The first chamber is fluidly isolated from the second chamber. The intermediate pane includes a first intermediate pane and a second intermediate pane, the first intermediate pane having the third inner surface and the fourth inner surface, the second intermediate pane having a fifth inner surface and a sixth inner surface, the third inner surface is coupled to the first spacer and the fourth inner surface is coupled to a third spacer, the fifth inner surface is coupled to the third spacer and the sixth inner surface is coupled to the spacer. The first spacer and the spacer are each composed of a metal or a metal alloy. Each of the first spacer and the spacer include a spacer base, a first spacer leg and a second spacer leg, the first spacer leg and the second spacer leg extend upwardly from opposed sides of the spacer base, the first spacer leg and the second spacer leg are spaced apart from each other to define a slot, and the first spacer and the spacer are sized to extend about a perimeter of the intermediate pane. A fill opening is defined in the spacer base and is fluidly coupled to a respective one of a first chamber defined between the first outer pane and the intermediate pane and a second chamber defined between the intermediate pane and the second outer pane. A first sealant is coupled to the first spacer leg and a second sealant is coupled to the second spacer leg. The first sealant and the second sealant are the same. The first spacer and the spacer are each composed of a polymer based material. The third inner surface includes a tin oxide coating. The first outer surface and the second outer surface include a scratch resistant coating. At least one of the first inner surface and the second inner surface includes a low emissivity coating. A perimeter of the intermediate pane is less than a perimeter of each of the first outer pane and the second outer pane.

Also provided is a method of manufacturing a multiple pane insulated glazing unit. The method includes providing a first outer pane including a first outer surface opposite a first inner surface, and the first outer pane has a first thickness defined between the first outer surface and the first inner surface. The method includes coupling a first spacer the first inner surface with a first sealant, and the first spacer includes a second sealant opposite the first sealant. The method includes coupling a third inner surface of an intermediate pane to the first spacer with the second sealant. The intermediate pane includes a fourth inner surface opposite the third inner surface, the intermediate pane has a third thickness defined between the third inner surface and the fourth inner surface that is less than the first thickness, and the third thickness is between about 0.2 millimeters (mm) to about 1.2 millimeters (mm). The method includes coupling a spacer to the fourth inner surface with the first sealant, and the spacer includes the first sealant opposite the second sealant. The method includes coupling a second inner surface of a second outer pane to the spacer with the second sealant to form a subassembly. The second outer pane includes a second outer surface opposite the second inner surface, and the second outer pane has a second thickness defined between the second outer surface and the second inner surface that is the same as the first thickness.

The method includes heating the subassembly at a predetermined temperature to form a seal with the first sealant and the second sealant while substantially simultaneously pressing the subassembly to a predetermined width for the multiple pane insulated glazing unit. The method includes applying a coating to at least one of the first outer surface, the first inner surface, the third inner surface, the fourth inner surface, the second inner surface and the second outer surface. The method includes filling a first chamber defined between the first outer pane and the intermediate pane with a fluid through a fill opening defined through the first spacer, and sealing the fill opening.

### DESCRIPTION OF THE DRAWINGS

The exemplary embodiments will hereinafter be described in conjunction with the following drawing figures, wherein like numerals denote like elements, and wherein:

FIG. 1 is a perspective partially cross-sectional illustration of a fenestration unit, such as a vertical sliding window, which includes an exemplary multiple pane insulated glazing unit in accordance with the various teachings of the present disclosure;

FIG. 2 is a cross-sectional view of the fenestration unit of FIG. 1, taken along line 2-2 of FIG. 1;

FIG. 3 is perspective view of the multiple pane insulated glazing unit of the fenestration unit of FIG. 1;

FIG. 4 is a cross-sectional view of the multiple pane insulated glazing unit, taken along line 4-4 of FIG. 3;

FIG. 5 is an exploded view of the multiple pane insulated glazing unit;

FIG. 6 is a detail view of a spacer associated with the multiple pane insulated glazing unit taken from 6 on FIG. 5, in which a fill opening associated with the spacer is sealed with a mechanical fastener;

FIG. 7 is a detail view of a spacer associated with the multiple pane insulated glazing unit taken from 6 on FIG. 5, in which the fill opening associated with the spacer is sealed with a cannulated mechanical fastener and a capillary tube;

FIG. 8 is a detail cross-sectional view of the spacer taken at 8 on FIG. 4;

FIG. 9 is a cross-sectional view of another exemplary multiple pane insulated glazing unit for use with the fenestration unit of FIG. 1 according to various embodiments;

FIG. 10 is a cross-sectional view of another exemplary multiple pane insulated glazing unit for use with the fenestration unit of FIG. 1 according to various embodiments;

FIG. 11 is a detail cross-sectional view of a spacer for use with the multiple pane insulated glazing unit of FIG. 10 taken at 11 on FIG. 10;

FIG. 12 is a cross-sectional view of another exemplary multiple pane insulated glazing unit for use with the fenestration unit of FIG. 1 according to various embodiments;

FIG. 13A is a detail cross-sectional view of an exemplary outer edge sealing spacer arrangement for use with the multiple pane insulated glazing unit of FIG. 3 according to various embodiments;

FIG. 13B is an exploded cross-sectional view of the outer edge sealing spacer arrangement of FIG. 13A, which illustrates a seat separate from a shoe;

FIG. 14A is a detail cross-sectional view of another exemplary outer edge sealing spacer arrangement for use with the multiple pane insulated glazing unit of FIG. 3 according to various embodiments;

FIG. 14B is an exploded cross-sectional view of the outer edge sealing spacer arrangement of FIG. 14A, which illustrates a seat separate from a shoe;

FIG. 15A is a detail cross-sectional view of another exemplary outer edge sealing spacer arrangement for use with the multiple pane insulated glazing unit of FIG. 3 according to various embodiments;

FIG. 15B is an exploded cross-sectional view of the outer edge sealing spacer arrangement of FIG. 15A, which illustrates a seat separate from a shoe;

FIG. 16 is a flowchart that illustrates a method of manufacturing the multiple pane insulated glazing unit of FIGS. 1-12 according to various embodiments; and

FIG. 17 is a flowchart that illustrates a method of manufacturing the multiple pane insulated glazing unit of FIGS. 13A-15B according to various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. In addition, those skilled in the art will appreciate that embodiments of the present disclosure may be practiced in conjunction with any type of fenestration unit that would benefit from a multiple pane insulated glazing unit and the use of the multiple pane insulated glazing unit with a sliding window described herein is merely one exemplary embodiment according to the present disclosure. Further, it should be noted that many alternative or additional functional relationships or physical connections may be present in an embodiment of the present disclosure. In addition, while the figures shown herein depict an example with certain arrangements of elements, additional intervening elements, devices, features, or components may be present in an actual embodiment. It should also be understood that the drawings are merely illustrative and may not be drawn to scale.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. Also, as used herein, the term “about” denotes within 10% to account for manufacturing tolerances. As used herein, the term “substantially” denotes within 10% to account for manufacturing tolerances.

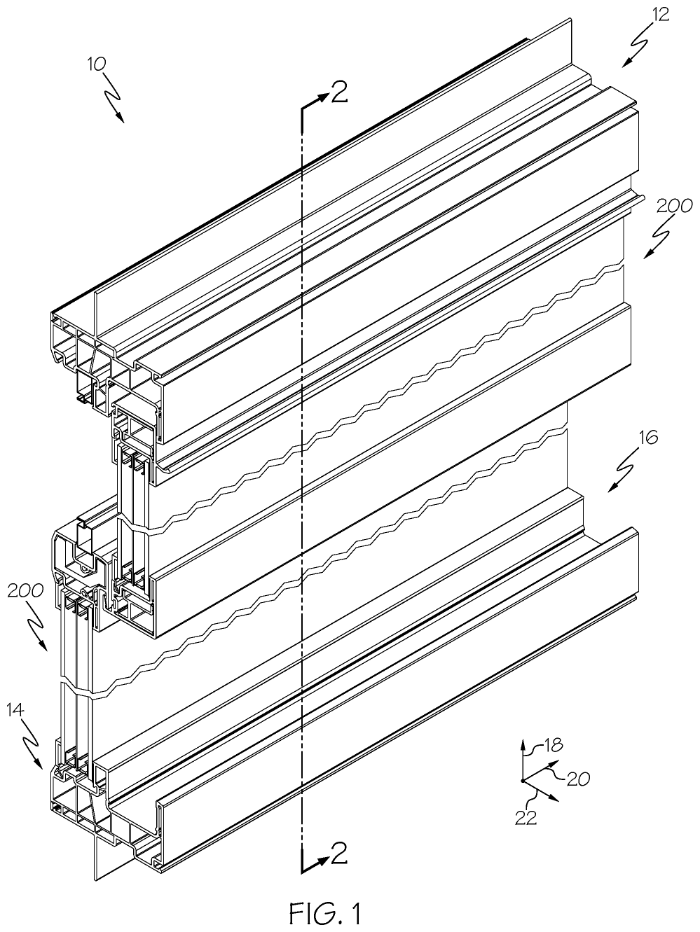

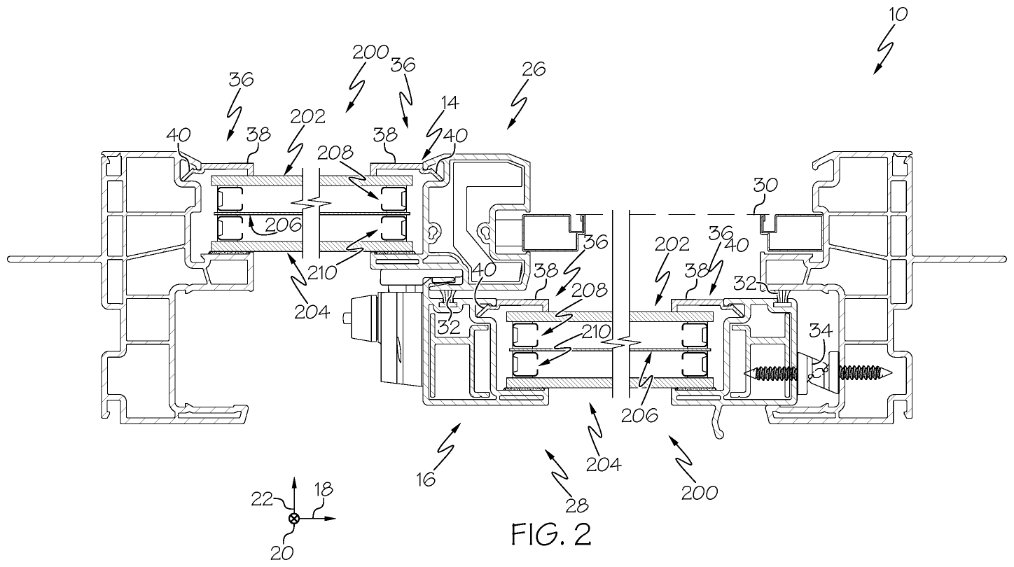

With reference to FIGS. 1 and 2, a fenestration unit 10 including a multiple pane insulated glazing unit 200 is shown. In this example, the fenestration unit 10 is a sliding window, such as a vertical sliding window, which includes two multiple pane insulated glazing units 200. It should be noted, however, that the present disclosure may be applicable to other types of fenestration units, including, but not limited to horizontal sliding doors, horizontal sliding windows, casement windows, awnings, skylights, etc. In this example, the fenestration unit 10 includes a fenestration frame 12, a fixed, first sash 14 and a movable, second sash 16. The fenestration frame 12 in this example is composed of a polymeric material, such as polyvinyl chloride, which is extruded, however, the fenestration frame 12 may be composed of other materials, including, but not limited to aluminum, wood, cladded wood, wood plastic composite, etc. The fenestration frame 12 supports the first sash 14 and the second sash 16. The first sash 14 is a fixed, non-active sash that is fixedly supported within the fenestration frame 12 and is immovable relative to the fenestration frame 12. The second sash 16 is a sliding sash that is supported within the fenestration frame 12 for sliding movement along a vertical axis 18. The vertical axis 18 is perpendicular to a lateral or horizontal axis 20 (i.e., lateral or horizontal direction), and an interior/exterior axis 22 is perpendicular to the vertical axis 18 and the horizontal axis 20. The sashes 14, 16 are supported within the fenestration frame 12 and are offset along the interior/exterior axis 22 such that the second sash 16 partially overlaps the first sash 14. Generally, the second sash 16 is movable between a first position, shown in FIG. 2, in which the second sash 16 is closed; a second position, in which the second sash 16 is open to enable ventilation through the fenestration unit 10; and various positions in between the first position and the second position. When the fenestration unit 10 is coupled to a structure, such as a building, an exterior side 26 of the fenestration unit 10 is disposed on an exterior of the building, while an interior side 28 of the fenestration unit 10 is disposed in an interior of the building (FIG. 2).

In this example, with reference to FIG. 2, a screen 30 is coupled to the fenestration frame 12 so as to be covered by the second sash 16 in the closed, first position. In the second position, the screen 30 is exposed to enable fluids, such as air, to flow through the fenestration unit 10. The second sash 16 may include one or more seals 32, such as brush seals, which assist in inhibiting debris, fluids, etc. from entering through the movement of the second sash 16. The second sash 16 and the fenestration frame 12 may also include interlocking seals 34, which ensures debris, fluids, etc. does not enter through the fenestration frame 12 around the second sash 16. Generally, each of the multiple pane insulated glazing units 200 is removably retained within the respective sash 14, 16 via one or more glass stops 36. In this example, each of the sashes 14, 16 include two glass stops 36 on opposite sides of the respective sash 14, 16. The glass stops 36 each include a support flange 38 and a flexible leg 40. The support flange 38 is in contact with and adjacent to the respective multiple pane insulated glazing unit 200 when the glass stops 36 are coupled to the respective sash 14, 16. The flexible leg 40 releasably couples the glass stops 36 to the respective sash 14, 16. In one example, each flexible leg 40 is received within a channel 42 defined in the respective sash 14, 16 such that a rotation of the support flange 38 relative to the channel 42 of the respective sash 14, 16 releases the glass stop 36 from the sash 14, 16. This enables the multiple pane insulated glazing unit 200 to be removed for cleaning or replacement, for example.

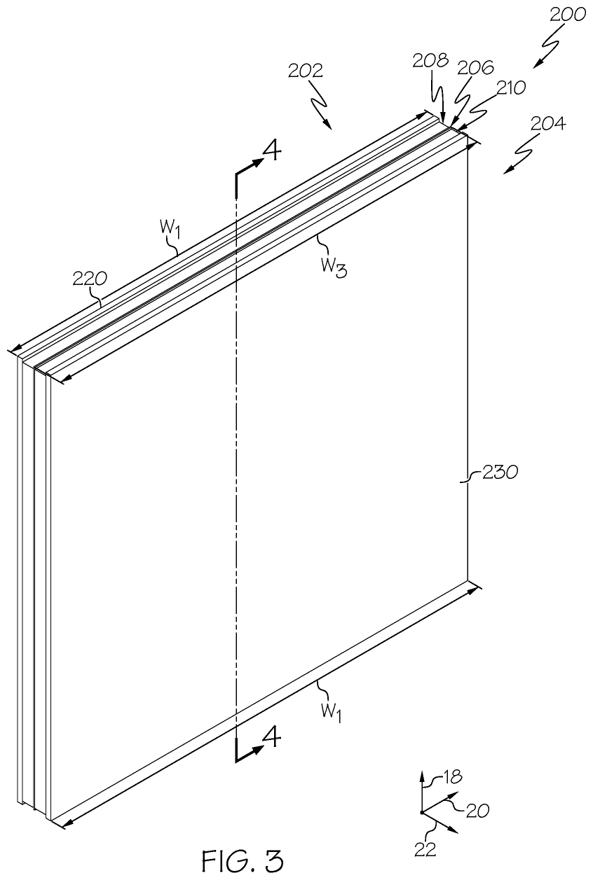

With reference to FIG. 3, one of the multiple pane insulated glazing units 200 is shown in greater detail. As each of the multiple pane insulated glazing units 200 is the same, a single multiple pane insulated glazing unit 200 will be described in detail herein for ease of description. Generally, the multiple pane insulated glazing unit 200 is a multiple pane glazing assembly, which assists in reducing the passage of thermal energy through the fenestration unit 10. In one example, the multiple pane insulated glazing unit 200 includes a first outer pane 202, a second outer pane 204, a third intermediate pane 206, a first spacer 208 and a second spacer 210.

In this example, the first outer pane 202 is positioned proximate the exterior side 26 of the fenestration unit 10, and the second outer pane 204 is positioned proximate the interior side 28 of the fenestration unit 10. In one example, the first outer pane 202, the second outer pane 204 and the third intermediate pane 206 are composed of glass, and have about the same glass composition. The first outer pane 202, the second outer pane 204 and the third intermediate pane 206 may be formed using a glass float process. In this example, the first outer pane 202, the second outer pane 204 and the third intermediate pane 206 are each composed of boron-free soda lime silicate glass. For example, each of the first outer pane 202 and the second outer pane 204 are composed of about 68 weight percent (wt %) to about 74 weight percent (wt %) of silicon dioxide (SiO₂); about 12 weight percent (wt %) to about 16 weight percent (wt %) of sodium oxide (Na₂O); about 0 weight percent (wt %) to about 1.1 weight percent (wt %) of potassium oxide (K₂O); about 4 weight percent (wt %) to about 13 weight percent (wt %) of Calcium Oxide (CaO); about 0 weight percent (wt %) to about 4.5 weight percent (wt %) of magnesium oxide (MgO); about 0 weight percent (wt %) to about 4.8 weight percent (wt %) of aluminum oxide (Al₂O₃); less than about 0.3 weight percent (wt %) of sulfur trioxide SO₃; and less than about 0.6 weight percent (wt %) of total iron oxide (Fe₂O₃ and FeO). In certain instances, less than about 0.5 weight percent (wt %) of Cerium oxide (CeO₂) and titanium dioxide (TiO₂) may be added to allow for a higher iron content. The total iron oxide content assists in filtering infrared and ultraviolet light. Generally, more than 25% of the total iron oxide content is iron oxide (FeO) as a higher concentration of iron oxide (FeO) is beneficial for infrared and ultraviolet light filtering. It should be noted that the weight percent of the total iron in the first outer pane 202, the second outer pane 204 and the third intermediate pane 206 may be reduced if higher visible light transmission is desired. In addition, one or more of the first outer pane 202, the second outer pane 204 and the third intermediate pane 206 may be annealed and/or tempered. In this example, the first outer pane 202 and the second outer pane 204 are annealed.

Generally, silicon dioxide acts as a glass network former, and alkali (sodium oxides and potassium oxides) and alkaline-earth oxides (calcium and magnesium oxides) act as a glass network modifier. Aluminum oxide acts as an intermediate for the glass network, and the sulfur acts as a refining agent. Generally, the use of this glass composition enables the first outer pane 202, the second outer pane 204 and the third intermediate pane 206 to have good chemical durability, high mechanical performance, and good thermal stability. This glass composition also provides for high throughput rate in the float glass manufacturing process, and the cost of manufacturing this glass composition using the float glass manufacturing process is relatively low compared to a vertical fusion manufacturing process.

In this example, the first outer pane 202, the second outer pane 204 and the third intermediate pane 206 have about the same coefficient of thermal expansion (CTE) as the first outer pane 202, the second outer pane 204 and the third intermediate pane 206 are composed of about the same glass composition. The CTE of each of the first outer pane 202, the second outer pane 204 and the third intermediate pane 206 is more than 70×10\hat{ }−7/° C. over a temperature range of 0 to 300 degrees Celsius (° C.), and in one example, is about 90 to about 100×10\hat{ }−7/° C. over a temperature range of 0 to 300 degrees Celsius (° C.). By providing the first outer pane 202, the second outer pane 204 and the third intermediate pane 206 with about the same glass composition and about the same CTE, each of the first outer pane 202, the second outer pane 204 and the third intermediate pane 206 expand and contract about evenly or at about the same rate when exposed to increases and decreases in temperature. In addition, providing the first outer pane 202, the second outer pane 204 and the third intermediate pane 206 with about the same glass composition and about the same CTE, the first spacer 208 and the second spacer 210 are not compromised during expansion/contraction of the first outer pane 202, the second outer pane 204 and the third intermediate pane 206. Thus, providing the first outer pane 202, the second outer pane 204 and the third intermediate pane 206 with about the same glass composition and about the same CTE also reduces a stress acting on the first spacer 208 and the second spacer 210, which ensures an integrity of a seal formed between the first spacer 208, the second spacer 210 and the respective ones of the first outer pane 202, the second outer pane 204 and the third intermediate pane 206. By maintaining an integrity of the seal defined between the first spacer, the second spacer 210 and the respective ones of the first outer pane 202, the second outer pane 204 and the third intermediate pane 206, ingress of moisture between the respective ones of the first outer pane 202, the second outer pane 204 and the third intermediate pane 206 is inhibited. In addition, with the panes 202, 204, 206 expanding and contracting at a same rate by having about the same CTE, the fenestration unit 10 is unlikely to be subject to image distortion, which may occur when CTEs between panes of a glazing unit are different.

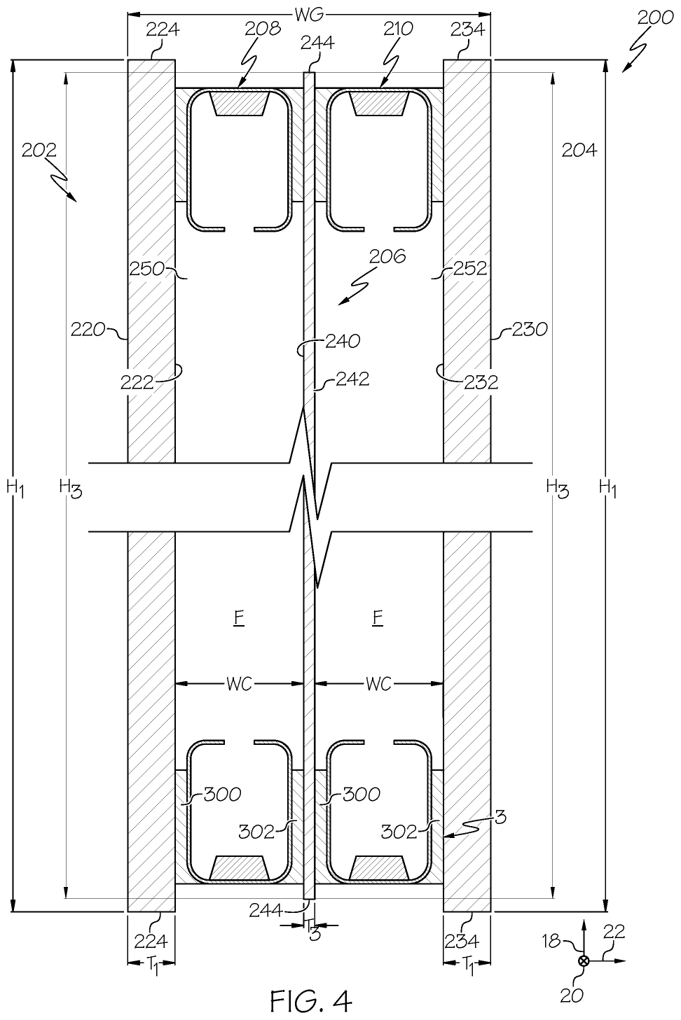

With reference to FIG. 4, the first outer pane 202 includes a first outer surface 220 and a first inner surface 222 that is opposite the first outer surface 220. In this example, the first outer pane 202 is rectangular, and includes a plurality of first edges or sides 224. It should be noted, however, that the first outer pane 202 may have any desired shape, including, but not limited to, circular, trapezoidal, square, or generally any polygonal shape that corresponds with the shape of the second outer pane 204 and the third intermediate pane 206. In one example, the first outer surface 220 is coated, and includes a hard coating or scratch resistant coating, including, but not limited to silica and other oxides or nitrides with high surface hardness. In other embodiments, the first outer surface 220 may be uncoated. The first inner surface 222 is coated, and includes soft coating such as a low emissivity coating, including, but not limited to silver (Ag), copper (Cu), platinum (Pt), rhodium (Rh), nickel (Ni), Chromium (Cr), or combinations thereof in an alloy, etc. The first outer pane 202 has a thickness T1 defined between the first outer surface 220 and the first inner surface 222 or in the interior/exterior axis 22 of about three millimeters (mm). In one example, the first outer pane 202 has a height H1 defined between opposed first sides 224 in the vertical axis 18 of about 800 millimeters (mm) and a width W1 defined between opposed first sides 224 (FIG. 3) in the horizontal axis 20 of about 700 millimeters (mm). It should be noted that the height H1 and the width W1 (FIG. 3) of the first outer pane 202 may vary based on the fenestration frame 12 associated with the multiple pane insulated glazing unit 200, and thus, the values of the height H1 and the width W1 are merely examples.

With continued reference to FIG. 4, the second outer pane 204 includes a second outer surface 230 and a second inner surface 232 that is opposite the second outer surface 230. In this example, the second outer pane 204 is rectangular, and includes a plurality of second edges or sides 234. It should be noted, however, that the second outer pane 204 may have any desired shape, including, but not limited to, circular, trapezoidal, square, or generally any polygonal shape that corresponds with the shape of the first outer pane 202 and the third intermediate pane 206. In one example, the second outer surface 230 is coated, and includes a hard coating or scratch resistant coating, including, but not limited to silica and other oxides or nitrides with high surface hardness, a tin oxide coating, or a transparent conductive oxide coating. The second inner surface 232 is coated, and includes a soft coating such as a low emissivity coating, including, but not limited to silver (Ag), copper (Cu), platinum (Pt), rhodium (Rh), nickel (Ni), Chromium (Cr), or combinations thereof in an alloy, etc. The second outer pane 204 has the same thickness defined between the second outer surface 230 and the second inner surface 232 or in the interior/exterior axis 22 as the first outer pane 202, or the second outer pane 204 has the thickness T1 of about three millimeters (mm). In one example, the second outer pane 204 has same height defined between opposed second sides 234 in the vertical axis 18 and the same width W1 defined between opposed second sides 234 (FIG. 3) in the horizontal axis 20 as the first outer pane 202, or the second outer pane 204 has the height H1 and the width W1.

The third intermediate pane 206 is positioned between the first outer pane 202 and the second outer pane 204. The third intermediate pane 206 includes a third inner surface 240 and a fourth inner surface 242 that is opposite the third inner surface 240. In this example, the third intermediate pane 206 is rectangular, and includes a plurality of third edges or sides 244. It should be noted, however, that the third intermediate pane 206 may have any desired shape, including, but not limited to, circular, trapezoidal, square, or generally any polygonal shape that corresponds with the shape of the first outer pane 202 and the second outer pane 204. In one example, the third inner surface 240 is coated, and includes a hard coating or scratch resistant coating, including, but not limited to silica and other oxides or nitrides with high surface hardness, a tin oxide coating, or a transparent conductive oxide coating. The fourth inner surface 242 may also be coated with a hard coating such as a scratch resistant coating, including, but not limited to silica and other oxides or nitrides with high surface hardness. In certain embodiments, the fourth inner surface 242 may be uncoated. In addition, in certain embodiments, the third inner surface 240 and/or the fourth inner surface 242 may include a soft coating such as a low emissivity coating, including, but not limited to silver (Ag), copper (Cu), platinum (Pt), rhodium (Rh), nickel (Ni), Chromium (Cr), or combinations thereof in an alloy, etc. The low emissivity coating may have an emissivity of about 0.02 to about 0.07, and a solar transmittance of about 0.2 to about 0.7. Generally, the hard coatings, such as the scratch resistant coatings, are coated onto the surfaces of the respective panes 202, 204, 206 during the float glass manufacturing process, using a pyrolytic coating process where the temperature bonds the hard coating onto the respective surface. For the soft coatings, the metallic elements are deposited onto the surface of the respective panes 202, 204, 206 at a relatively lower temperature than that of the pyrolytic coating process using a magnetron sputtering process, for example.

In one example, the third intermediate pane 206 is a skinny pane or has a thickness T3 that is different and less than the thickness T1 of the first outer pane 202 and the second outer pane 204. In one example, the thickness T3 is about 0.2 millimeters (mm) to about 1.2 millimeters (mm) and in this example, is about 0.7 millimeters (mm). In one example, the third intermediate pane 206 has a height H3 defined between opposed third sides 244 in the vertical axis 18 and a width W3 defined between opposed third sides 244 (FIG. 3) in the horizontal axis 20. In one example, the height H3 is different and less than the height H1 by about 0.5 millimeters (mm) to about 3.0 millimeters (mm); and the width W3 is different and less than the width W1 by about 0.5 millimeters (mm) to about 3.0 millimeters (mm). Stated another way, a perimeter of the third intermediate pane 206 defined by the third sides 244 is different and less than a perimeter of the first outer pane 202 defined by the first sides 224 and different and less than a perimeter of the second outer pane 204 defined by the second sides 234 by about 0.5 millimeters (mm) to about 3.0 millimeters (mm) on each of the third sides 244 such that the third intermediate pane 206 is recessed relative to the first outer pane 202 and the second outer pane 204. Thus, generally, an area of the third intermediate pane 206 is different and less than an area of each of the first outer pane 202 and the second outer pane 204. By providing the third intermediate pane 206 with the height H3 and the width W3 that is different and less than the height H1 and the width W1 of the first outer pane 202 and the second outer pane 204, the third intermediate pane 206 provides for ease of assembly of the multiple pane insulated glazing unit 200. In this regard, the third intermediate pane 206 serves as a visual guide for the coupling of the first spacer 208 or the second spacer 210 to the third intermediate pane 206. In addition, by providing the third intermediate pane 206 with the height H3 and the width W3 that is different and less than the height H1 and the width W1 of the first outer pane 202 and the second outer pane 204, the third intermediate pane 206 is less prone to damage during transportation and handling. Further, by reducing the size of the third intermediate pane 206, the first edges or sides 224 and/or second edges or sides 234 of the thicker outer panes 202, 204 are the surfaces of the multiple pane insulated glazing unit 200 that are contacted during handling and transportation. Thus, by reducing a size of the third intermediate pane 206, the third edges or sides 244 of the third intermediate pane 206 are protected from contact or experiencing an impact when being handled or transported. Further, the reduced size (height H3 and width W3) of the third intermediate pane 206 acts as a shock absorber for the multiple pane insulated glazing unit 200, because the recessed edges of the third intermediate pane 206 eliminate the potential for the third edges or sides 244 of the third intermediate pane 206 to contact the first sides 224 and/or second sides 234 of the respective outer panes 202, 204 during a compression of the multiple pane insulated glazing unit 200 caused by contraction of the fenestration frame 12 and/or the sashes 14, 16 due to changes in temperature.

With the third intermediate pane 206 positioned between the first outer pane 202 and the second outer pane 204, a first chamber 250 and a second chamber 252 are defined between the third intermediate pane 206 and the respective one of the first outer pane 202 and the second outer pane 204. In this example, the first chamber 250 is defined between the first inner surface 222 and the third inner surface 240. The second chamber 252 is defined the fourth inner surface 242 and the second inner surface 232. The first spacer 208 encloses the first chamber 250 and the second spacer 210 encloses the second chamber 252 such that the first chamber 250 is fluidly isolated from the second chamber 252. In one example, each of the first chamber 250 and the second chamber 252 have a chamber width WC, which is the same. In this example, the chamber width WC is about 0.7 millimeters (mm). The first chamber 250 and the second chamber 252 provide insulation between the panes 202, 204, 206, which cooperates in reducing the transmission of thermal energy through the multiple pane insulated glazing unit 200.

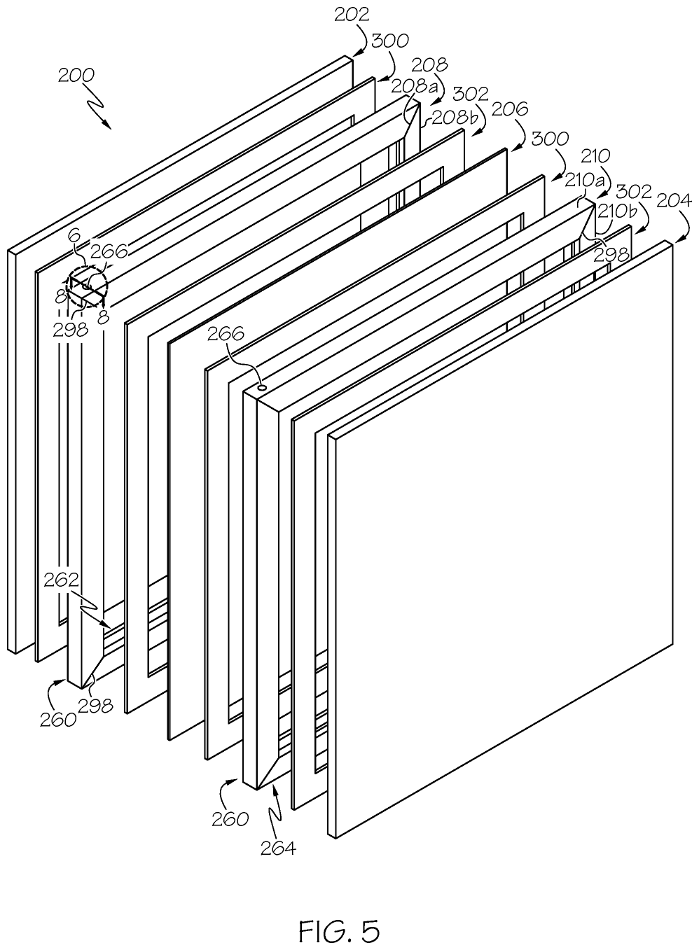

Generally, the first spacer 208 and the second spacer 210 form a seal about the perimeter of the respective one of the first outer pane 202 and the third intermediate pane 206, and the second outer pane 204 and the third intermediate pane 206. With reference back to FIG. 5, the first spacer 208 and the second spacer 210 are about the same or are the same. In one example, the first spacer 208 and the second spacer 210 are each composed of a metal or metal alloy, including, but not limited to stainless steel, tin plated steel, etc. The first spacer 208 and the second spacer 210 may be extruded as one-piece or a monolithic structure, and folded into a rectangular shape to comport with the shape of the first outer pane 202, the second outer pane 204 and the third intermediate pane 206. It should be noted that based on the shape of the first outer pane 202, the second outer pane 204 and the third intermediate pane 206, the first spacer 208 and the second spacer 210 may be extruded, cast, additively manufactured, etc. to have a shape that comports or conforms with the shape of the first outer pane 202, the second outer pane 204 and the third intermediate pane 206. Generally, the first spacer 208 and the second spacer 210 are sized to correspond to the size of the third intermediate pane 206 such that when coupled to the third intermediate pane 206, the first spacer 208 and the second spacer 210 are flush with the third intermediate pane 206 along each of the third sides 244.

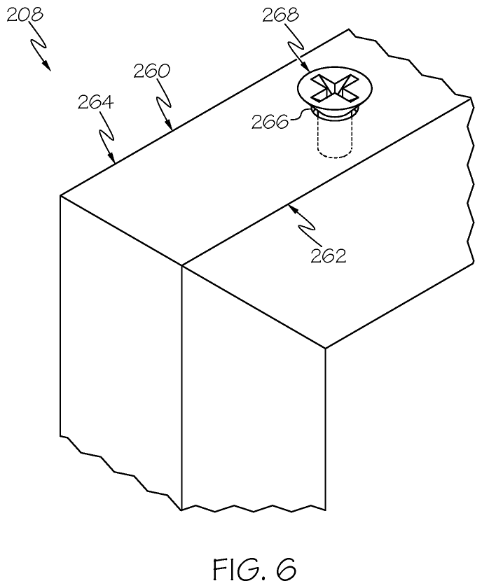

Each of the first spacer 208 and the second spacer 210 includes a spacer base 260, a first spacer leg 262 and a second spacer leg 264. Each of the first spacer 208 and the second spacer 210 are hollow. The spacer base 260 is substantially planar, and defines an outer perimeter of each of the first spacer 208 and the second spacer 210. The spacer base 260 defines a fill opening 266, which enables a nozzle, tube or other conduit to be inserted to fill the respective one of the first chamber 250 and the second chamber 252 (FIG. 4) with a fluid F once the multiple pane insulated glazing unit 200 is assembled, if desired. In one example, the fluid F includes, but is not limited to a pressurized gas, air-argon mix, argon-krypton mix, air, etc. In this example, the fluid F is the same between the first chamber 250 and the second chamber 252, but in other embodiments, the fluid F may be different between the first chamber 250 and the second chamber 252. In one example, with reference to FIG. 6, a detail view of the first spacer 208 is shown. It should be understood that a detail view of this region of the second spacer 210 is the same. As shown in FIG. 6, the fill opening 266 is circular, and comprises a threaded bore for receipt of a mechanical fastener 268, such as a screw. Once the respective one of the first chamber 250 and the second chamber 252 is filled with the fluid F, the mechanical fastener 268 is coupled or threaded into the fill opening 266 to seal the fill opening 266, and thus, form a substantially fluid tight seal about the respective one of the first chamber 250 and the second chamber 252 with the respective one of the first spacer 208 and the second spacer 210. A sealant, such as butyl, may be positioned over the mechanical fastener 268 or may be positioned about the perimeter of the spacer base 260 to form a seal along the spacer base 260.

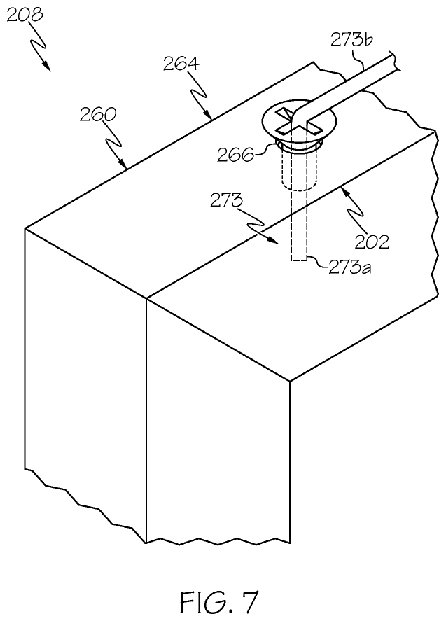

It should be noted, however, in certain embodiments, such as high altitude embodiments, the first chamber 250 and the second chamber 252 may not include the fluid F. In this example, with reference to FIG. 7, a detail view of the first spacer 208 is shown. It should be understood that a detail view of this region of the second spacer 210 is the same. As shown in FIG. 7, the fill opening 266 is circular, and comprises the threaded bore for receipt of a cannulated mechanical fastener 270 and a capillary tube 273. In this example, the cannulated mechanical fastener 270 is a cannulated screw, and the capillary tube 273 passes through the cannulated mechanical fastener 270 to extend into an interior of the respective one of the first chamber 250 and the second chamber 252. The capillary tube 273 is substantially L-shaped, and includes a first leg 273a coupled to a second leg 273b. The second leg 273b is substantially perpendicular to the first leg 273a. The first leg 273a is coupled to the cannulated mechanical fastener 270 to extend through the cannulated mechanical fastener 270 and into the respective one of the first chamber 250 and the second chamber 252. The second leg 273b extends outwardly and away from the cannulated mechanical fastener 270 along the spacer base 260 to enable a pressure within the respective one of the first chamber 250 and the second chamber 252 to equalize with the ambient pressure.

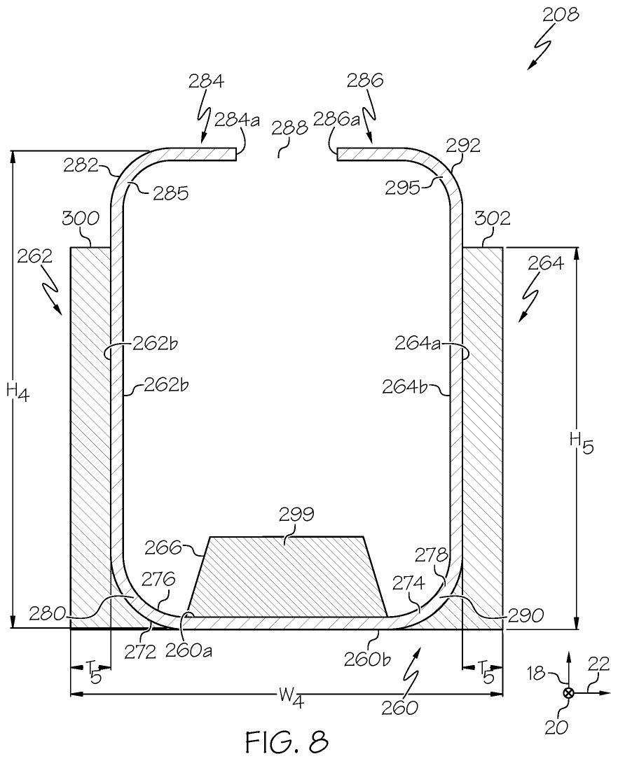

With reference to FIG. 8, a detail-cross-sectional view of the first spacer 208 is shown with the understanding that the cross-section of the second spacer 210 is the same. The spacers 208, 210 have a substantially U-shape in cross-section. Generally, each of the first spacer leg 262 and the second spacer leg 264 have a spacer leg height H4 of about 7.6 millimeters (mm). Each of the spacers 208, 210 has a spacer width W4 of about 5.5 millimeters (mm) to about 8.1 millimeters (mm). The spacer base 260 is flat, and has a first base side 272 opposite a second base side 274. As shown, the fill opening 266 extends inward, in the same direction of as the first spacer leg 262 and the second spacer leg 264. The first spacer leg 262 extends outwardly from the first base side 272, and the second spacer leg 264 extends outwardly from the second base side 274. In one example, a first chamfer 276 is defined between the first base side 272 and the first spacer leg 262, and a second chamfer 278 is defined between the second base side 274 and the second spacer leg 264. The chamfers 276, 278 assist in the extrusion of the first spacer 208 and the second spacer 210. The first spacer leg 262 has a first leg end 280 coupled to the first base side 272 by the first chamfer 276, and an opposite second leg end 282. The first spacer leg 262 also has a first leg side 262a opposite a second leg side 262b. The first leg side 262a defines an exterior surface of the spacer 208, 210, and the second leg side 262b defines an interior surface of the spacer 208, 210. The first spacer leg 262 extends along an axis substantially perpendicular to an axis defined parallel to the first base side 272. In this example, the second leg end 282 includes a first axial tab 284. The first axial tab 284 is coupled to the second leg end 282 with a third chamfer 285. The first axial tab 284 extends toward the second spacer leg 264, and is substantially perpendicular to the axis along which the first spacer leg 262 extends. A terminal end 284a of the first axial tab 284 is spaced apart from a terminal end 286a of a second axial tab 286 of the second spacer leg 264 to define a slot 288. The slot 288 imparts the spacer 208, 210 with flexibility, and enables the spacer 208, 210 to bend or flex with changes in temperature, which reduces a stress acting on the spacer 208, 210.

The second spacer leg 264 has a third leg end 290 coupled to the second base side 274 by the second chamfer 278, and an opposite fourth leg end 292. The second spacer leg 264 also has a third leg side 264a opposite a fourth leg side 264b. The third leg side 264a defines an exterior surface of the spacer 208, 210, and the fourth leg side 264b defines an interior surface of the spacer 208, 210. The second spacer leg 264 extends along an axis substantially perpendicular to an axis defined parallel to the second base side 274. In this example, the fourth leg end 292 includes the second axial tab 286. The second axial tab 286 is coupled to the fourth leg end 292 with a fourth chamfer 295. The second axial tab 286 extends toward the first spacer leg 262, and is substantially perpendicular to the axis along which the second spacer leg 264 extends.

In the example of the spacers 208, 210 being formed as one-piece or monolithic, with reference back to FIG. 5, each of the first spacer leg 262 and the second spacer leg 264 may have corresponding notches 298 defined to form a corner of the respective spacer 208, 210. In one example, the notches 298 are substantially V-shaped, and enable the spacers 208, 210 to be folded into the rectangular shape to comport with the shape of the panes 202, 204, 206. Generally, the spacers 208, 210 are sized and shaped to follow the perimeter of the third intermediate pane 206, and to be proximate, but spaced apart from the perimeter of the respective first outer pane 202 and the second outer pane 204. The spacers 208, 210 may each include a first end 208a, 210a and a second end 208b, 210b that is opposite the first end 208a, 210a prior to the forming of the spacer 208, 210 into the rectangular shape. Once the spacer 208, 210 is formed into the rectangular shape, the first end 208a, 210a is coupled to the second end 208b, 210b. The first end 208a, 210a may be coupled to the second end 208b, 210b via mechanical fasteners, adhesives, crimping, welding, etc. In certain instances, the second end 208b, 210b may be received over the first end 208a, 210a to overlap the first end 208a, 210a, and the second end 208b, 210b is coupled to the first end 208a, 210a via mechanical fasteners.

In certain examples, the first spacer 208 and the second spacer 210 may also include a desiccant 299. In one example, the desiccant 299 is applied to an interior surface 260a of the spacer base 260 of each of the first spacer 208 and the second spacer 210. The interior surface 260a of the spacer base 260 is opposite an exterior surface 260b of the spacer base 260. The desiccant 299 may comprise any suitable desiccant 299 configured to inhibit moisture within the respective one of the first chamber 250 and the second chamber 252. The desiccant 299 may be coupled to the interior surface 260a via any suitable technique, including, but not limited to, adhesives, etc.

In this example, with reference back to FIG. 8, a first sealant 300 and a second sealant 302 are coupled to the exterior surface of the spacer 208, 210 defined by the respective first leg side 262a and the third leg side 264a. The first sealant 300 and the second sealant 302 are the same in this example, and include, but are not limited to, butyl double sided tape, double sided polymeric adhesive, silicone, modified asphalt, etc. In this example, each of the first sealant 300 and the second sealant 302 has an adhesive on both or opposed sides, and is used to couple the respective spacer 208, 210 to the respective pane 202, 204, 206. The first sealant 300 is coupled to the first leg side 262a of the first spacer leg 262 to extend about the perimeter of the respective spacer 208, 210. The second sealant 302 is coupled to the third leg side 264a of the second spacer leg 264 to extend about the perimeter of the respective spacer 208, 210. Generally, the first sealant 300 and the second sealant 302 are coupled to the respective leg sides 262a, 264b so as to extend along the respective spacer leg 262, 264 from proximate or at the spacer base 260 toward the respective one of the second leg end 282 and the fourth leg end 292. The first sealant 300 and the second sealant 302 are coupled along the chamfer 276, 278 to ensure a seal is formed along the spacer 208, 210 between the spacer base 260 and the respective one of the first spacer leg 262 and the second spacer leg 264.

In this example, the spacer base 260 is devoid of a sealant, which ensures that the fill opening 266 remains open during the assembly of the multiple pane insulated glazing unit 200. In this regard, the exterior surface 260b of the spacer base 260 of each of the first spacer 208 and the second spacer 210 is devoid of a sealant. By providing the exterior surface 260b devoid of a sealant, the thermal performance of the multiple pane insulated glazing unit 200 is improved due to the lack of the sealant along the perimeter of the first spacer 208 and the second spacer 210. In this regard, by providing the exterior surface 260b devoid or without a sealant, the first spacer 208 and the second spacer 210 may be coupled at the perimeter or outer edges or third sides 244 of the third intermediate pane 206, which increases an area captured between the first outer pane 202 and the second outer pane 204. The increase in area provided by positioning the first spacer 208 and the second spacer 210 at the perimeter or outer edges of the third intermediate pane 206 results in the U-factor associated with the multiple pane insulated glazing unit 200 being reduced by about 0.002 or about 0.002 lower. Thus, by providing the spacer base 260 of the first spacer 208 and the second spacer 210 devoid of a sealant, the thermal performance of the multiple pane insulated glazing unit 200 is increased as shown by the reduction in the U-factor by about 0.002. In addition, the multiple pane insulated glazing unit 200 is easier to handle, as the perimeter of the multiple pane insulated glazing unit 200 is not sticky.

The first sealant 300 and the second sealant 302 have a height H5 of about 6 millimeters (mm) upon completion of manufacturing. The first sealant 300 and the second sealant 302 have a thickness T5, which in one example, is about 1.2 millimeters (mm) to about 1.3 millimeters (mm) upon completion of manufacturing. With reference to FIG. 4, once assembled, the multiple pane insulated glazing unit 200 has a width WG of about 20.4 millimeters (mm) to about 23 millimeters (mm) upon completion of manufacturing.

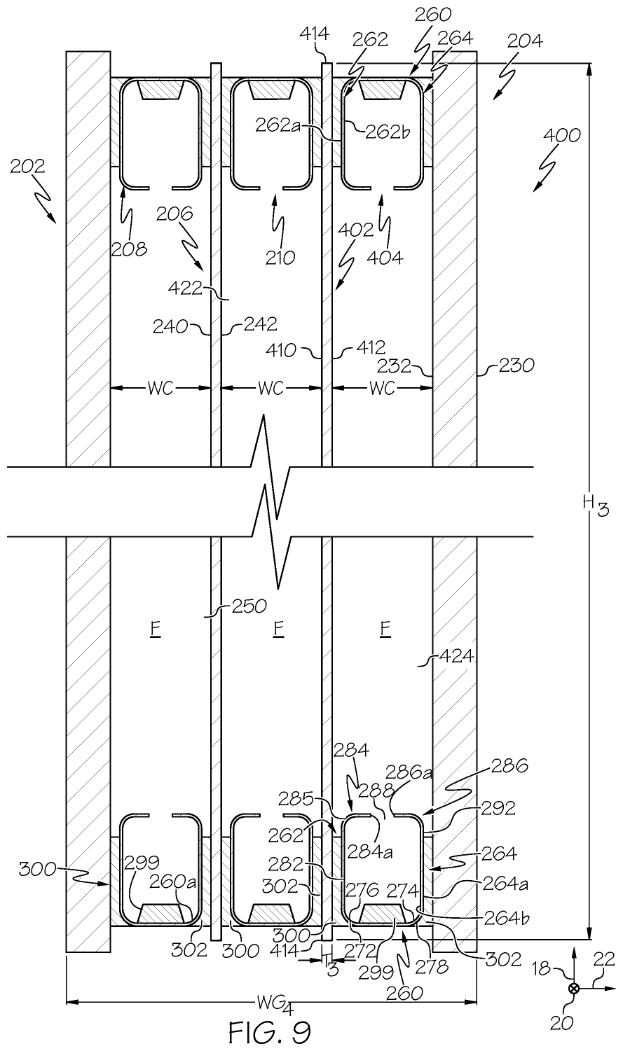

It should be noted that while the multiple pane insulated glazing unit 200 has been discussed with regard to FIGS. 1-8 as having the first outer pane 202, the second outer pane 204 and the third intermediate pane 206, a multiple pane insulated glazing unit may be configured with additional intermediate panes to assist in thermal efficiency. For example, with reference to FIG. 9, a multiple pane insulated glazing unit 400 for use with the fenestration frame 12 of FIG. 1 is shown. As the multiple pane insulated glazing unit 400 includes features that are the same or similar to the multiple pane insulated glazing unit 200 discussed with reference to FIGS. 1-8, the same reference numerals will be used to denote the same or similar components. Generally, the multiple pane insulated glazing unit 400 is a multiple pane glazing assembly, which assists in reducing the passage of thermal energy through the fenestration unit 10. In this example, the multiple pane insulated glazing unit 400 includes the first outer pane 202, the second outer pane 204, the third intermediate pane 206, the first spacer 208, the second spacer 210, a fourth intermediate pane 402 and a third spacer 404.

In this example, fourth intermediate pane 402 is positioned between the third intermediate pane 206 and the second outer pane 204. The fourth intermediate pane 402 has the same glass composition as each of the first outer pane 202, the second outer pane 204 and the third intermediate pane 206, and is composed of boron-free soda lime silicate glass. In addition, the fourth intermediate pane 402 may be annealed and/or tempered. In this example, the first outer pane 202, the second outer pane 204, the third intermediate pane 206 and the fourth intermediate pane 402 have about the same coefficient of thermal expansion (CTE) as the first outer pane 202, the second outer pane 204, the third intermediate pane 206 and the fourth intermediate pane 402 are composed of about the same glass composition. The CTE of the fourth intermediate pane 402 is more than 70×10\hat{ }−7/° C. over a temperature range of 0 to 300 degrees Celsius (° C.). By providing the first outer pane 202, the second outer pane 204, the third intermediate pane 206 and the fourth intermediate pane 402 with about the same glass composition and about the same CTE, each of the first outer pane 202, the second outer pane 204, the third intermediate pane 206 and the fourth intermediate pane 402 expand and contract about evenly or at about the same rate when exposed to increases and decreases in temperature.

The fourth intermediate pane 402 includes a fifth inner surface 410 and a sixth inner surface 412 that is opposite the fifth inner surface 410. In this example, the fourth intermediate pane 402 is rectangular, and includes a plurality of fourth sides 414. It should be noted, however, that the fourth intermediate pane 402 may have any desired shape, including, but not limited to, circular, trapezoidal, square, or generally any polygonal shape that corresponds with the shape of the first outer pane 202, the second outer pane 204 and the third intermediate pane 206. In one example, the fifth inner surface 410 is coated, and includes a hard coating or scratch resistant coating, including, but not limited to silica and other oxides or nitrides with high surface hardness, a tin oxide coating, or a transparent conductive oxide coating. The sixth inner surface 412 is also be coated with a hard coating, including, but not limited to silica and other oxides or nitrides with high surface hardness. In certain embodiments, the sixth inner surface 412 may be uncoated. In addition, in certain embodiments, the fifth inner surface 410 and/or the sixth inner surface 412 may include a soft coating such as a low emissivity coating, including, but not limited to silver (Ag), copper (Cu), platinum (Pt), rhodium (Rh), nickel (Ni), Chromium (Cr), or combinations thereof in an alloy, etc. The low emissivity coating may have an emissivity of about 0.02 to about 0.07, and a solar transmittance of about 0.2 to about 0.7.

In one example, the fourth intermediate pane 402 is a skinny pane or has the thickness T3 that is different and less than the thickness T1 of the first outer pane 202 and the second outer pane 204. In one example, the fourth intermediate pane 402 has the height H3 defined between opposed fourth sides 414 in the vertical axis 18 and the width W3 defined between opposed fourth sides 414 in the horizontal axis 20. Thus, a perimeter of the fourth intermediate pane 402 defined by the fourth sides 414 is different and less than a perimeter of the first outer pane 202 defined by the first sides 224 and different and less than a perimeter of the second outer pane 204 defined by the second sides 234 by about 0.5 millimeters (mm) to about 3.0 millimeters (mm) on each of the fourth sides 414 such that the fourth intermediate pane 402 is recessed relative to the first outer pane 202 and the second outer pane 204. Thus, generally, an area of the fourth intermediate pane 402 is different and less than an area of each of the first outer pane 202 and the second outer pane 204. The perimeter of the fourth intermediate pane 402 is the about same as the perimeter of the third intermediate pane 206. By providing the fourth intermediate pane 402 with the height H3 and the width W3 that is different and less than the height H1 and the width W1 of the first outer pane 202 and the second outer pane 204, the fourth intermediate pane 402 provides for ease of assembly of the multiple pane insulated glazing unit 400. In this regard, the fourth intermediate pane 402 serves as a visual guide for the coupling of the second spacer 210 or the third spacer 404 to the fourth intermediate pane 402. In addition, by providing the fourth intermediate pane 402 with the height H3 and the width W3 that is different and less than the height H1 and the width W1 of the first outer pane 202 and the second outer pane 204, the fourth intermediate pane 402 is less prone to damage during transportation.

With the fourth intermediate pane 402 positioned between the third intermediate pane 206 and the second outer pane 204, a second chamber 422 and a third chamber 424 are defined between the fourth intermediate pane 402 and the respective one of the third intermediate pane 206 and the second outer pane 204. In this example, the second chamber 422 is defined between the fourth inner surface 242 and the fifth inner surface 410. The third chamber 424 is defined the sixth inner surface 412 and the second inner surface 232. The second spacer 210 encloses the second chamber 422, and the third spacer 404 encloses the third chamber 424 such that the second chamber 422 is fluidly isolated from the third chamber 424. In one example, each of the second chamber 422 and the third chamber 424 have the chamber width WC, which is the same. The first chamber 250, the second chamber 422 and the third chamber 424 provide insulation between the panes 202, 204, 206, 402 which cooperates in reducing the transmission of thermal energy through the multiple pane insulated glazing unit 400.

Generally, the second spacer 210 and the third spacer 404 form a seal about the perimeter of the respective one of the third intermediate pane 206 and the fourth intermediate pane 402, and the fourth intermediate pane 402 and the second outer pane 204. The first spacer 208, the second spacer 210 and the third spacer 404 are about the same or are the same. In one example, the third spacer 404 is composed of a metal or metal alloy, including, but not limited to stainless steel, tin plated steel, etc. The third spacer 404 may be extruded as one-piece or a monolithic structure, and folded into a rectangular shape to comport with the shape of the first outer pane 202, the second outer pane 204, the third intermediate pane 206 and the fourth intermediate pane 402. It should be noted that based on the shape of the first outer pane 202, the second outer pane 204, the third intermediate pane 206 and the fourth intermediate pane 402, the first spacer 208, the second spacer 210 and the third spacer 404 may be extruded, cast, additively manufactured, etc. to have a shape that comports or conforms with the shape of the first outer pane 202, the second outer pane 204, the third intermediate pane 206 and the fourth intermediate pane 402.

The third spacer 404 includes the spacer base 260, the first spacer leg 262 and the second spacer leg 264. The third spacer 404 is hollow. The spacer base 260 is substantially planar, and defines an outer perimeter of the third spacer 404. The spacer base 260 defines the fill opening 266, which enables a nozzle, tube or other conduit to be inserted to fill the third chamber 424 (FIG. 4) with the fluid F once the multiple pane insulated glazing unit 400 is assembled, if desired. In this example, the fluid F is the same between the first chamber 250, the second chamber 422 and the third chamber 424, but in other embodiments, the fluid F may be different between the first chamber 250, the second chamber 422 and the third chamber 424. The mechanical fastener 268 (FIG. 7) may be coupled to the fill opening 266 or the cannulated mechanical fastener 270 and the capillary tube 273 may be coupled to the fill opening 266 (FIG. 8) depending upon the embodiment of the fenestration unit 10.

The third spacer 404 has a substantially U-shape. The first chamfer 276 is defined between the first base side 272 and the first spacer leg 262, and the second chamfer 278 is defined between the second base side 274 and the second spacer leg 264. The first leg side 262a defines an exterior surface of the third spacer 404, and the second leg side 262b defines an interior surface of the third spacer 404. The second leg end 282 includes a first axial tab 284. The first axial tab 284 is coupled to the second leg end 282 with the third chamfer 285. The terminal end 284a of the first axial tab 284 is spaced apart from the terminal end 286a of the second axial tab 286 of the second spacer leg 264 to define the slot 288. The second spacer leg 264 also has the third leg side 264a opposite the fourth leg side 264b. The third leg side 264a defines an exterior surface of the third spacer 404, and the fourth leg side 264b defines an interior surface of the third spacer 404.

In the example of the third spacer 404 being formed as one-piece or monolithic, each of the first spacer leg 262 and the second spacer leg 264 may have the notches 298 defined to form a corner of the third spacer 404. The third spacer 404 may include a first end and a second end that is opposite the first end prior to the forming of the third spacer 404 into the rectangular shape. Once the third spacer 404 is formed into the rectangular shape, the first end is coupled to the second end. Generally, the third spacer 404 is sized and shaped to follow the perimeter of the fourth intermediate pane 402, and to be proximate, but spaced apart from the perimeter of the second outer pane 204. The first end may be coupled to the second end via mechanical fasteners, adhesives, crimping, welding, etc.

In this example, the first sealant 300 and the second sealant 302 are coupled to the exterior surface of the third spacer 404 defined by the respective first leg side 262a and the third leg side 264a. The first sealant 300 is coupled to the first leg side 262a of the first spacer leg 262 to extend about the perimeter of the third spacer 404. The second sealant 302 is coupled to the third leg side 264a of the second spacer leg 264 to extend about the perimeter of the third spacer 404. Generally, the first sealant 300 and the second sealant 302 are coupled to the respective leg sides 262a, 264b so as to extend along the respective spacer leg 262, 264 from proximate or at the spacer base 260 toward the respective one of the second leg end 282 and the fourth leg end 292. The first sealant 300 and the second sealant 302 are coupled along the chamfer 276, 278 to ensure a seal is formed along the third spacer 404 between the spacer base 260 and the respective one of the first spacer leg 262 and the second spacer leg 264. In this example, the spacer base 260 is devoid of sealant, which ensures that the fill opening 266 remains open during the assembly of the multiple pane insulated glazing unit 400. Once assembled, the multiple pane insulated glazing unit 400 has a width WG4 of about 27.9 millimeters (mm) upon completion of manufacturing.

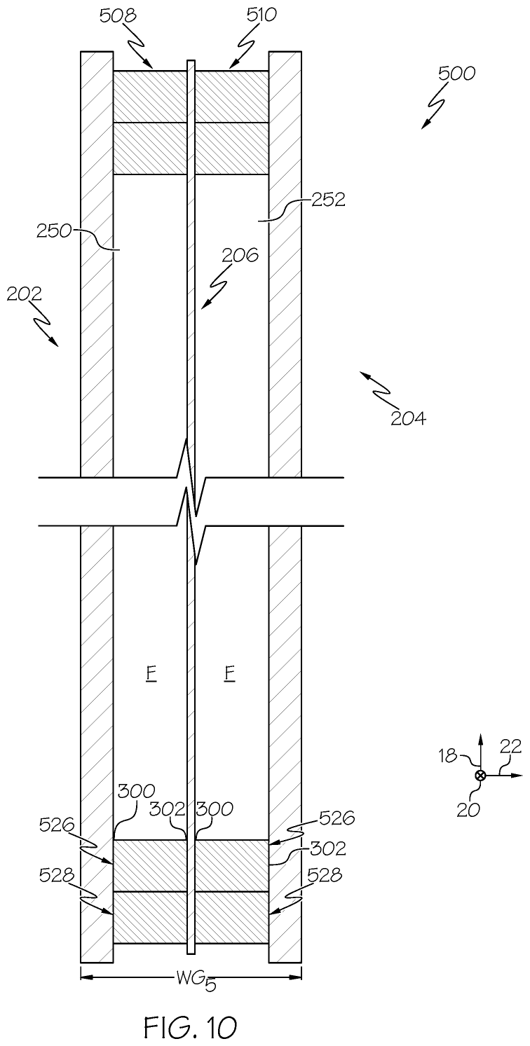

It should be noted that while the multiple pane insulated glazing unit 200 has been discussed with regard to FIGS. 1-8 as having the first spacer 208 and the second spacer 210 having a substantially U-shape in cross-section, a multiple pane insulated glazing unit may be configured with different spacer configurations to assist in thermal efficiency. For example, with reference to FIG. 10, a multiple pane insulated glazing unit 500 for use with the fenestration frame 12 of FIG. 1 is shown. As the multiple pane insulated glazing unit 500 includes features that are the same or similar to the multiple pane insulated glazing unit 200 discussed with reference to FIGS. 1-8, the same reference numerals will be used to denote the same or similar components. Generally, the multiple pane insulated glazing unit 500 is a multiple pane glazing assembly, which assists in reducing the passage of thermal energy through the fenestration unit 10. In this example, the multiple pane insulated glazing unit 500 includes the first outer pane 202, the second outer pane 204, the third intermediate pane 206, a first spacer 508 and a second spacer 510.

The first spacer 508 encloses the first chamber 250 and the second spacer 510 encloses the second chamber 252 such that the first chamber 250 is fluidly isolated from the second chamber 252. Generally, the first spacer 508 and the second spacer 510 form a seal about the perimeter of the respective one of the first outer pane 202 and the third intermediate pane 206, and the second outer pane 204 and the third intermediate pane 206. The first spacer 508 and the second spacer 510 are about the same or are the same. In one example, the first spacer 508 and the second spacer 510 are each composed of a polymeric material, including, but not limited to ethylene propylene diene monomer, a polyethylene cellular foam, a thermoplastic, modified asphalt, silicone, etc. The first spacer 508 and the second spacer 510 may be extruded as one-piece or a monolithic structure, and bent into a rectangular shape to comport with the shape of the first outer pane 202, the second outer pane 204 and the third intermediate pane 206. Alternatively, the first spacer 508 and the second spacer 510 may be formed in multiple pieces and assembled to form the rectangular shape. It should be noted that based on the shape of the first outer pane 202, the second outer pane 204 and the third intermediate pane 206, the first spacer 208 and the second spacer 210 may be extruded, cast, molded, etc. to have a shape that comports or conforms with the shape of the first outer pane 202, the second outer pane 204 and the third intermediate pane 206.

Each of the first spacer 508 and the second spacer 510 includes a first portion 526 and an opposite second portion 528. The first portion 526 and the second portion 528 have a generally rectangular shape, however, the first portion 526 and the second portion 528 may have any suitable shape. The first portion 526 is coupled to the second portion 528, and jointly the first portion 526 and the second portion 528 form the respective one of the first spacer 508 and the second spacer 510. Each of the first portion 526 and the second portion 528 include a first sidewall 530, a second sidewall 532 opposite the first sidewall 530, a third sidewall 534 and a fourth sidewall 536 opposite the third sidewall 534. The first sidewall 530 of each of the first spacer 508 and the second spacer 510 cooperate to define a first surface 538 of the respective one of the first spacer 508 and the second spacer 510. The second sidewall 532 of each of the first spacer 508 and the second spacer 510 cooperate to define a second surface 540 of the respective one of the first spacer 508 and the second spacer 510. The third sidewall 534 of the first portion 526 defines an exterior surface of the respective one of the first spacer 508 and the second spacer 510. The third sidewall 534 of the second portion 528 defines an interior surface of the respective one of the first spacer 508 and the second spacer 510. The fourth sidewall 536 of the first portion 526 is coupled to the fourth sidewall 536 of the second portion 528 via adhesives, for example. In this example, the first portion 526 and the second portion 528 are solid in cross-section, but in other examples, the first portion 526 and the second portion 528 may be hollow in cross-section.

A fill opening may be defined through the first portion 526 and the second portion 528 to enable a nozzle, tube or other conduit to be inserted to fill the respective one of the first chamber 250 and the second chamber 252 (FIG. 10) with the fluid F once the multiple pane insulated glazing unit 500 is assembled, if desired. A sealant, such as a piece of butyl, may be positioned over the fill opening to form a seal over the fill opening. In other embodiments, such as high altitude embodiments, the first chamber 250 and the second chamber 252 may not include the fluid F. The fill opening may receive the capillary tube 273 to enable a pressure within the respective one of the first chamber 250 and the second chamber 252 to equalize with the ambient pressure.

The spacers 508, 510 have a substantially rectangular cross-section. Generally, each of the spacers 508, 510 has a spacer height SH4 of about 9.5 millimeters (mm). Each of the spacers 508, 510 has a spacer width SW4 of about 6.8 millimeters (mm) to 8.1 millimeters (mm). In the example of the spacers 508, 510 being formed as one-piece or monolithic, each of the spacers 508, 510 may have corresponding notches defined to form a corner of the respective spacer 508, 510. In one example, the notches are substantially V-shaped, and enable the spacer 508, 510 to be folded into the rectangular shape to comport with the shape of the panes 202, 204, 206. The spacers 508, 510 may each include a first end and a second end that is opposite the first end prior to the forming of the spacer 508, 510 into the rectangular shape. Once the spacer 508, 510 is formed into the rectangular shape, the first end is coupled to the second end. The first end may be coupled to the second end of the respective spacer 508, 510 via adhesives, etc. Generally, the spacers 508, 510 are sized and shaped to follow the perimeter of the third intermediate pane 206, and to be proximate, but spaced apart from the perimeter of the respective first outer pane 202 and the second outer pane 204.

In this example, with reference back to FIG. 10, the first sealant 300 and the second sealant 302 are coupled to the respective one of the first surface 538 defined by the first sidewalls 530 and the second surface 540 defined by the second sidewalls 532. The first sealant 300 is coupled to the first sidewalls 530 to extend about the perimeter of the respective spacer 508, 510. The second sealant 302 is coupled to the second sidewalls 532 to extend about the perimeter of the respective spacer 508, 510. The first sealant 300 of the first spacer 508 couples the first spacer 508 to the first outer pane 202, and the second sealant 302 of the first spacer 508 couples the first spacer 508 to the third intermediate pane 206. The first sealant 300 of the second spacer 510 couples the second spacer 510 to the third intermediate pane 206, and the second sealant 302 of the second spacer 510 couples the second spacer 510 to the second outer pane 204. In this example, the third sidewall 534 of the first portion 526 is devoid of sealant, which ensures that the fill opening remains open during the assembly of the multiple pane insulated glazing unit 500. Once assembled, the multiple pane insulated glazing unit 500 has a width WG5 of about 20.8 millimeters (mm) to about 23 millimeters (mm) upon completion of manufacturing.

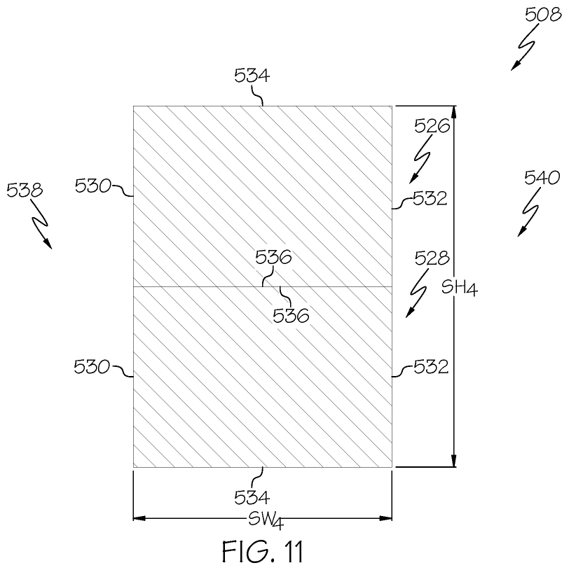

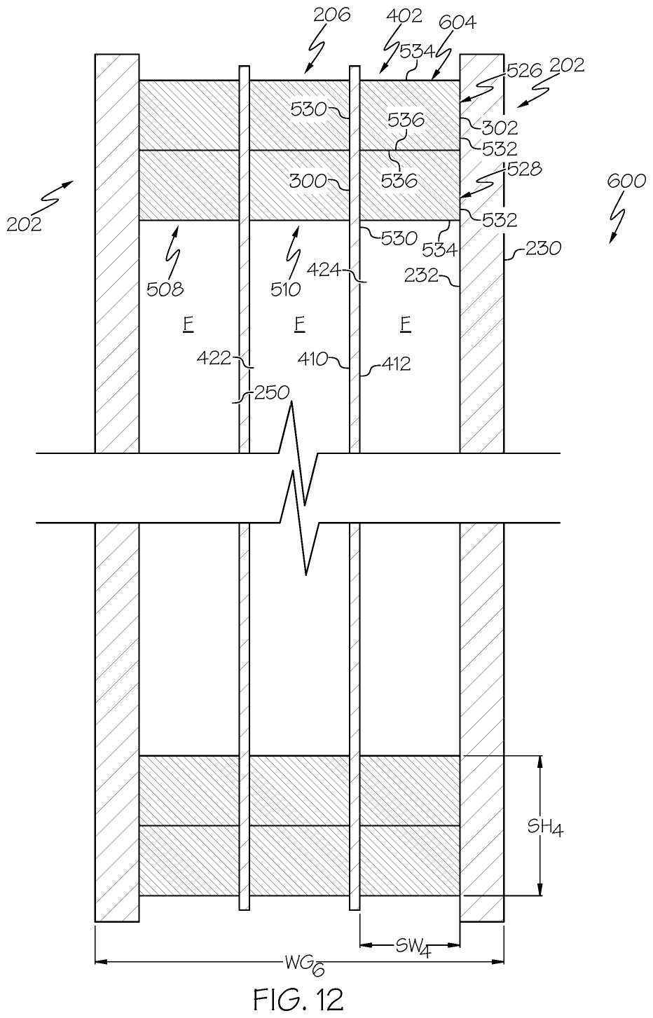

It should be noted that while the multiple pane insulated glazing unit 500 has been discussed with regard to FIGS. 10 and 11 as having the first outer pane 202, the second outer pane 204 and the third intermediate pane 206, a multiple pane insulated glazing unit may be configured with additional intermediate panes to assist in thermal efficiency. For example, with reference to FIG. 12, a multiple pane insulated glazing unit 600 for use with the fenestration frame 12 of FIG. 1 is shown. As the multiple pane insulated glazing unit 600 includes features that are the same or similar to the multiple pane insulated glazing unit 200 discussed with reference to FIGS. 1-8, the multiple pane insulated glazing unit 500 discussed with reference to FIG. 9 and the multiple pane insulated glazing unit 500 discussed with reference to FIGS. 10 and 11, the same reference numerals will be used to denote the same or similar components. Generally, the multiple pane insulated glazing unit 600 is a multiple pane glazing assembly, which assists in reducing the passage of thermal energy through the fenestration unit 10. In this example, the multiple pane insulated glazing unit 600 includes the first outer pane 202, the second outer pane 204, the third intermediate pane 206, the first spacer 508, the second spacer 510, the fourth intermediate pane 402 and a third spacer 604.

In this example, fourth intermediate pane 402 is positioned between the third intermediate pane 206 and the second outer pane 204. With the fourth intermediate pane 402 positioned between the third intermediate pane 206 and the second outer pane 204, the second chamber 422 and the third chamber 424 are defined between the fourth intermediate pane 402 and the respective one of the third intermediate pane 206 and the second outer pane 204. The second spacer 510 encloses the second chamber 422, and the third spacer 604 encloses the third chamber 424 such that the second chamber 422 is fluidly isolated from the third chamber 424. Generally, the second spacer 510 and the third spacer 604 form a seal about the perimeter of the respective one of the third intermediate pane 206 and the fourth intermediate pane 402, and the fourth intermediate pane 402 and the second outer pane 204.

The first spacer 508, the second spacer 510 and the third spacer 604 are about the same or are the same. In one example, the third spacer 604 is composed of a polymeric material, including, but not limited to ethylene propylene diene monomer, a polyethylene cellular foam, etc. The third spacer 604 may be extruded as one-piece or a monolithic structure, and bent into a rectangular shape to comport with the shape of the first outer pane 202, the second outer pane 204, the third intermediate pane 206 and the fourth intermediate pane 402. Alternatively, the third spacer 604 may be formed in multiple pieces and assembled to form the rectangular shape. It should be noted that based on the shape of the first outer pane 202, the second outer pane 204, the third intermediate pane 206 and the fourth intermediate pane 402, the third spacer 604 may be extruded, cast, molded, etc. to have a shape that comports or conforms with the shape of the first outer pane 202, the second outer pane 204, the third intermediate pane 206 and the fourth intermediate pane 402.

The third spacer 604 includes the first portion 526 and the opposite second portion 528. The third sidewall 534 of the first portion 526 defines an exterior surface of the third spacer 604. The third sidewall 534 of the second portion 528 defines an interior surface of the third spacer 604. The fourth sidewall 536 of the first portion 526 is coupled to the fourth sidewall 536 of the second portion 528 via adhesives, for example. In this example, the first portion 526 and the second portion 528 are solid in cross-section, but in other examples, the first portion 526 and the second portion 528 may be hollow in cross-section. A fill opening may be defined through the first portion 526 and the second portion 528 to enable a nozzle, tube or other conduit to be inserted to fill the third chamber 424 with the fluid F once the multiple pane insulated glazing unit 600 is assembled, if desired. A sealant, such as a piece of butyl, may be positioned over the fill opening to form a seal over the fill opening. In other embodiments, such as high altitude embodiments, the third chamber 424 may not include the fluid F. The fill opening may receive the capillary tube 273 to enable a pressure within the third chamber 424 to equalize with the ambient pressure.

The third spacer 604 has a substantially rectangular cross-section. Generally, the third spacer 604 has the spacer height SH4 of about 9.5 millimeters (mm). Each of the spacers 508, 510 has the spacer width SW4 of about 6.8 millimeters (mm). In the example of the third spacer 604 being formed as one-piece or monolithic, the third spacer 604 may have the corresponding notches defined to form a corner of the third spacer 604. The third spacer 604 may include a first end and a second end that is opposite the first end prior to the forming of the third spacer 604 into the rectangular shape. Once the third spacer 604 is formed into the rectangular shape, the first end is coupled to the second end. The first end may be coupled to the second end of the third spacer 604 via adhesives, etc.

In this example, the first sealant 300 and the second sealant 302 are coupled to the respective one of the first surface 538 defined by the first sidewalls 530 and the second surface 540 defined by the second sidewalls 532. The first sealant 300 is coupled to the first sidewalls 530 to extend about the perimeter of the third spacer 604. The second sealant 302 is coupled to the second sidewalls 532 to extend about the perimeter of the third spacer 604. The first sealant 300 of the third spacer 604 couples the third spacer 604 to the third intermediate pane 206, and the second sealant 302 of the first spacer 508 couples the first spacer 508 to the third intermediate pane 206. The first sealant 300 of the second spacer 510 couples the second spacer 510 to the fourth intermediate pane 402, and the second sealant 302 of the third spacer 604 couples the third spacer 604 to the second outer pane 204. In this example, the third sidewall 534 of the first portion 526 is devoid of sealant, which ensures that the fill opening remains open during the assembly of the multiple pane insulated glazing unit 600. Once assembled, the multiple pane insulated glazing unit 600 has a width WG6 of about 27.8 millimeters (mm) to about 31.8 millimeters (mm) upon completion of manufacturing.

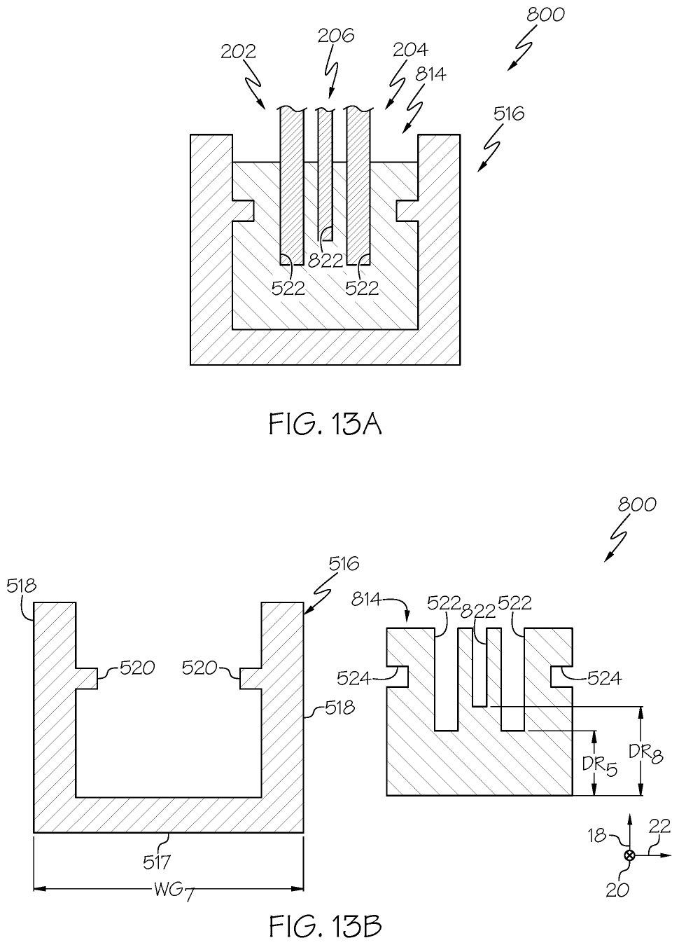

It should be noted that while the multiple pane insulated glazing unit 200 has been discussed with regard to FIGS. 1-8 as having the first spacer 208 and the second spacer 210 having a substantially U-shape in cross-section, a multiple pane insulated glazing unit may be configured with different spacer configurations to reduce an amount of sealant employed with the multiple pane insulated glazing unit. For example, with reference to FIGS. 13A and 13B, a multiple pane insulated glazing unit 800 for use with the fenestration frame 12 of FIG. 1 is shown. As the multiple pane insulated glazing unit 800 includes features that are the same or similar to the multiple pane insulated glazing unit 200 discussed with reference to FIGS. 1-8, the same reference numerals will be used to denote the same or similar components. In addition, as the multiple pane insulated glazing unit 800 includes features that are the same or similar to the outer edge sealing spacer arrangement 110 discussed in commonly assigned U.S. application Ser. No. 17/930,627 filed on Sep. 8, 2022 (Attorney Docket No. 380.0765US(119258)) to Kantola, et al., the relevant portion of which is incorporated by reference herein, the same reference numerals will be used to denote the same or similar components. Generally, the multiple pane insulated glazing unit 800 is a multiple pane glazing assembly, which assists in reducing the passage of thermal energy through the fenestration unit 10. In this example, the multiple pane insulated glazing unit 800 includes the first outer pane 202, the second outer pane 204, the third intermediate pane 206, a seat 814 and the shoe 516.

In this example, the perimeter of the first outer pane 202 and the second outer pane 204 are each received within the recesses 522 of the seat 814 such that an entirety of the perimeter is surrounded by portions of the seat 814. The perimeter of the third intermediate pane 206 is received within a recess 822 of the seat 814 such that an entirety of the perimeter is surrounded by portions of the seat 814. The recess 822 of the seat 814 may have a depth DRB, which is different and less that a depth DRS of the recesses 522 due to the difference in the size of the third intermediate pane 206. The seat 814 includes an elongated body that has a substantially rectangular cross-section. However, other cross-sectional shapes are possible. The seat 814 may be formed of various compressible materials that promote a secure hold between the seat 814 and the perimeter of the first outer pane 202, the second outer pane 204 and the third intermediate pane 206 therein. Suitable materials may include, but are not limited to, various natural and synthetic rubber materials, and various compressible polymeric materials. Various methods may be used to produce the seat 814 including, but not limited to, various extrusion processes.

The seat 814 is fixed within the shoe 516. The shoe 516 includes an elongated body having the base wall 517 and the pair of oppositely disposed side walls 518 extending from the base wall 517. The base wall 517 and the side walls 518 define therebetween a space that receives the seat 814. Distal edges of the side walls 518 define an opening to the space. In this example, the side walls 518 are perpendicular to the base wall 517 and parallel to each other to define a cross-section having a partial or truncated rectangular shape.

The shoe 516 may be formed of various rigid or semi-rigid materials such as, but not limited to, various polymeric, metallic, and composite materials. In one embodiment the shoe 516 is formed of polyvinylchloride (PVC). In another embodiment, the shoe 516 is formed of stainless steel. In yet another embodiment, the shoe 516 is formed of aluminum or an alloy thereof. In yet another embodiment, the shoe 516 is formed of a polymer-wood composite. Various methods may be used to produce the shoe 516 including, but not limited to, various extrusion processes.

The pair of couplings are located between the seat 814 and the shoe 516 that are configured to promote the seal between the seat 814 and the shoe 516 and thereby substantially seal chambers defined between the first outer pane 202 and the third intermediate pane 206; and the third intermediate pane 206 and the second outer pane 204. The couplings include ribs or protrusions 520 extending from and along interior sides of the side walls 518 into the space defined by the side walls 518 and the base wall 517 of the shoe 516, and a pair of corresponding grooves or channels 524 in the seat 814. The protrusions 520 are configured to be received within the channels 524 and function therein as barriers that impede relative movement between the seat 814 and the shoe 516 in directions parallel to the first outer pane 202, the second outer pane 204 and the third intermediate pane 206. That is, the protrusions 520 contact interior surfaces of the channels 524 and thereby reduce a likelihood that the seat 814 may move out of the opening of the shoe 516. In one example, the protrusions 520 have a rectangular cross-sectional shape configured to be received within corresponding rectangular-shaped channels 524 of the seat 814.

The protrusions 520 of the couplings may each include a solid body integral to the shoe 516, a solid body secured to the shoe 516, or a solid body having a coating thereon. The protrusions 520 and/or the coatings thereon may be formed of various materials such as, but not limited to, various polymeric, metallic, and composite materials. In some embodiments, the protrusions 520 include a thermosetting or thermoplastic material. Various methods may be used to produce the protrusions 520 including, but not limited to, various extrusion processes. If the protrusions 520 include coatings thereon, the coatings may be produced with various deposition processes including, but not limited to, physical application processes (e.g., painting) and physical vapor deposition (PVD) processes.

The chambers defined between the first outer pane 202, the second outer pane 204 and the third intermediate pane 206, and sealed about the perimeters thereof with the outer edge sealing spacer arrangement 110, are filled with the fluid F, if desired. The fluid F applies forces on the first outer pane 202, the second outer pane 204 and the third intermediate pane 206 along the interior/exterior axis 22, and on the seat 814 toward the base wall 517 of the shoe 516 or along the vertical axis 18. These forces expand and/or stretch the seat 814 in directions toward the side walls 518 and the base wall 517 of the shoe 516. Since the shoe 516 includes a rigid body, a clamping force is effectively applied on the seat 814 that secures the perimeter of the first outer pane 202, the second outer pane 204 and the third intermediate pane 206 in the recesses 522, 822 of the seat 814 and secures the seat 814 within the shoe 516. Thus, in this example, the multiple pane insulated glazing unit 800 does not include a sealant material to seal between the respective panes 202, 204, 206. In one example, the multiple pane insulated glazing unit 800 has a width WG8, which is about 19 millimeters (mm) to about 35 millimeters (mm).

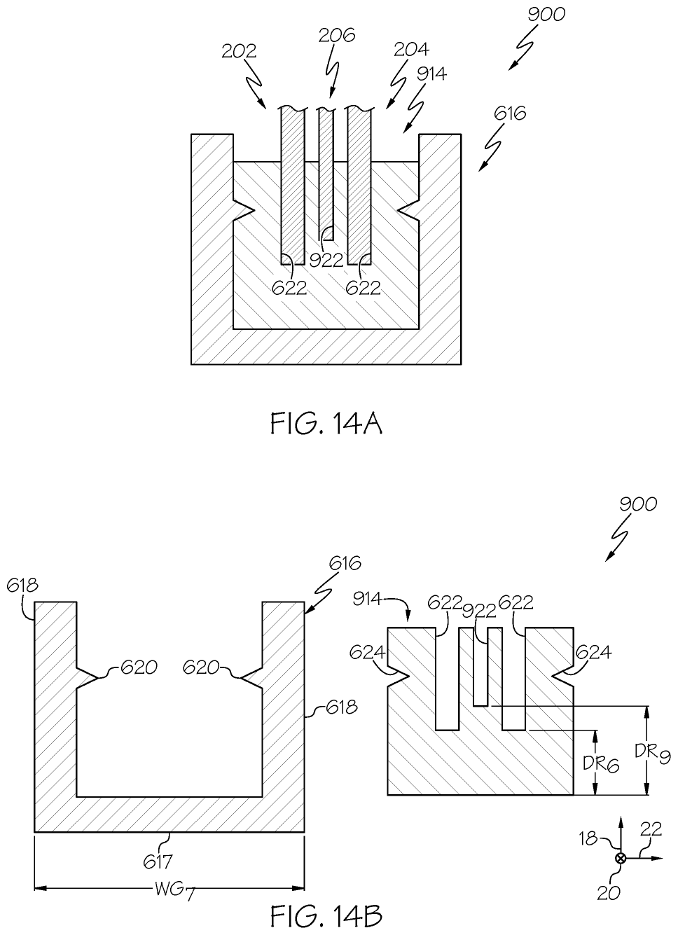

It should be noted that while the multiple pane insulated glazing unit 200 has been discussed with regard to FIGS. 1-8 as having the first spacer 208 and the second spacer 210 having a substantially U-shape in cross-section, a multiple pane insulated glazing unit may be configured with different spacer configurations to reduce an amount of sealant employed with the multiple pane insulated glazing unit. For example, with reference to FIGS. 14A and 14B, a multiple pane insulated glazing unit 900 for use with the fenestration frame 12 of FIG. 1 is shown. As the multiple pane insulated glazing unit 900 includes features that are the same or similar to the multiple pane insulated glazing unit 200 discussed with reference to FIGS. 1-8, the same reference numerals will be used to denote the same or similar components. In addition, as the multiple pane insulated glazing unit 900 includes features that are the same or similar to the outer edge sealing spacer arrangement 110 discussed in commonly assigned U.S. application Ser. No. 17/930,627 filed on Sep. 8, 2022 (Attorney Docket No. 380.0765US(119258)) to Kantola, et al., the relevant portion of which was previously incorporated by reference herein, the same reference numerals will be used to denote the same or similar components. Generally, the multiple pane insulated glazing unit 900 is a multiple pane glazing assembly, which assists in reducing the passage of thermal energy through the fenestration unit 10. In this example, the multiple pane insulated glazing unit 900 includes the first outer pane 202, the second outer pane 204, the third intermediate pane 206, a seat 914 and the shoe 616.

In this example, the perimeter of the first outer pane 202 and the second outer pane 204 are each received within the recesses 622 of the seat 914 such that an entirety of the perimeter is surrounded by portions of the seat 914. The perimeter of the third intermediate pane 206 is received within a recess 922 of the seat 914 such that an entirety of the perimeter is surrounded by portions of the seat 914. The recess 922 of the seat 914 may have a depth DR9, which is different and less that a depth DR6 of the recesses 622 due to the difference in the size of the third intermediate pane 206. The seat 914 includes an elongated body that has a substantially rectangular cross-section. However, other cross-sectional shapes are possible. The seat 914 may be formed of various compressible materials that promote a secure hold between the seat 914 and the perimeter of the first outer pane 202, the second outer pane 204 and the third intermediate pane 206 therein. Suitable materials may include, but are not limited to, various natural and synthetic rubber materials, and various compressible polymeric materials. Various methods may be used to produce the seat 914 including, but not limited to, various extrusion processes.

The seat 914 is fixed within the shoe 616. The shoe 616 includes an elongated body having the base wall 617 and the pair of oppositely disposed side walls 618 extending from the base wall 617. The base wall 617 and the side walls 618 define therebetween a space that receives the seat 914. Distal edges of the side walls 618 define an opening to the space. In this example, the side walls 618 are perpendicular to the base wall 617 and parallel to each other to define a cross-section having a partial or truncated rectangular shape.

The shoe 616 may be formed of various rigid or semi-rigid materials such as, but not limited to, various polymeric, metallic, and composite materials. In one embodiment the shoe 616 is formed of polyvinylchloride (PVC). In another embodiment, the shoe 616 is formed of stainless steel. In yet another embodiment, the shoe 616 is formed of aluminum or an alloy thereof. In yet another embodiment, the shoe 616 is formed of a polymer-wood composite. Various methods may be used to produce the shoe 616 including, but not limited to, various extrusion processes.

The pair of couplings are located between the seat 914 and the shoe 616 that are configured to promote the seal between the seat 914 and the shoe 616 and thereby substantially seal the chambers defined between the first outer pane 202 and the third intermediate pane 206; and the third intermediate pane 206 and the second outer pane 204. The couplings include ribs or protrusions 620 extending from and along interior sides of the side walls 618 into the space defined by the side walls 618 and the base wall 617 of the shoe 616, and a pair of corresponding grooves or channels 624 in the seat 914. The protrusions 620 are configured to be received within the channels 624 and function therein as barriers that impede relative movement between the seat 914 and the shoe 616 in directions parallel to the first outer pane 202, the second outer pane 204 and the third intermediate pane 206. That is, the protrusions 620 contact interior surfaces of the channels 624 and thereby reduce a likelihood that the seat 914 may move out of the opening of the shoe 616. In one example, the protrusions 620 have a triangular cross-sectional shape configured to be received within a corresponding triangular-shaped channel 624.

The protrusions 620 of the couplings may each include a solid body integral to the shoe 616, a solid body secured to the shoe 616, or a solid body having a coating thereon. The protrusions 620 and/or the coatings thereon may be formed of various materials such as, but not limited to, various polymeric, metallic, and composite materials. In some embodiments, the protrusions 620 include a thermosetting or thermoplastic material. Various methods may be used to produce the protrusions 620 including, but not limited to, various extrusion processes. If the protrusions 620 include coatings thereon, the coatings may be produced with various deposition processes including, but not limited to, physical application processes (e.g., painting) and physical vapor deposition (PVD) processes.

The chambers defined between the first outer pane 202, the second outer pane 204 and the third intermediate pane 206, and sealed about the perimeters thereof with the outer edge sealing spacer arrangement 110, are filled with the fluid F, if desired. The fluid F applies forces on the first outer pane 202, the second outer pane 204 and the third intermediate pane 206 along the interior/exterior axis 22, and on the seat 914 toward the base wall 617 of the shoe 616 or along the vertical axis 18. These forces expand and/or stretch the seat 914 in directions toward the side walls 618 and the base wall 617 of the shoe 616. Since the shoe 616 includes a rigid body, a clamping force is effectively applied on the seat 914 that secures the perimeter of the first outer pane 202, the second outer pane 204 and the third intermediate pane 206 in the recesses 622, 922 of the seat 914 and secures the seat 914 within the shoe 616. Thus, in this example, the multiple pane insulated glazing unit 900 does not include a sealant material to seal between the respective panes 202, 204, 206. In one example, the multiple pane insulated glazing unit 900 has a width WG8, which is about 19 millimeters (mm) to about 35 millimeters (mm).

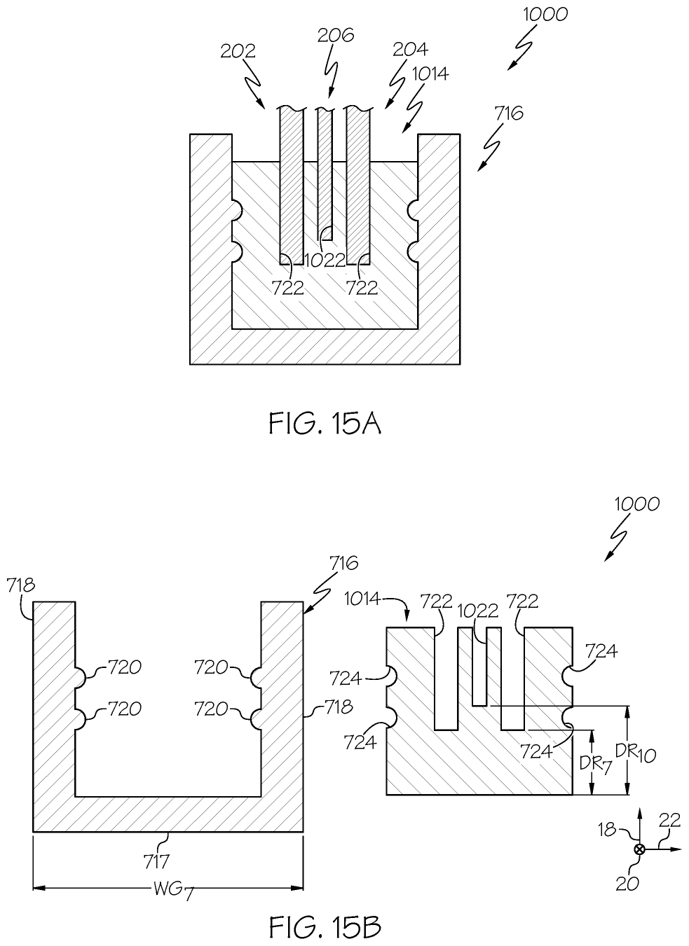

It should be noted that while the multiple pane insulated glazing unit 200 has been discussed with regard to FIGS. 1-8 as having the first spacer 208 and the second spacer 210 having a substantially U-shape in cross-section, a multiple pane insulated glazing unit may be configured with different spacer configurations to reduce an amount of sealant employed with the multiple pane insulated glazing unit. For example, with reference to FIGS. 15A and 15B, a multiple pane insulated glazing unit 1000 for use with the fenestration frame 12 of FIG. 1 is shown. As the multiple pane insulated glazing unit 1000 includes features that are the same or similar to the multiple pane insulated glazing unit 200 discussed with reference to FIGS. 1-8, the same reference numerals will be used to denote the same or similar components. In addition, as the multiple pane insulated glazing unit 1000 includes features that are the same or similar to the outer edge sealing spacer arrangement 110 discussed in commonly assigned U.S. application Ser. No. 17/930,627 filed on Sep. 8, 2022 (Attorney Docket No. 380.0765US(119258)) to Kantola, et al., the relevant portion of which was previously incorporated by reference herein, the same reference numerals will be used to denote the same or similar components. Generally, the multiple pane insulated glazing unit 1000 is a multiple pane glazing assembly, which assists in reducing the passage of thermal energy through the fenestration unit 10. In this example, the multiple pane insulated glazing unit 1000 includes the first outer pane 202, the second outer pane 204, the third intermediate pane 206, a seat 1014 and the shoe 716.

In this example, the perimeter of the first outer pane 202 and the second outer pane 204 are each received within the recesses 722 of the seat 1014 such that an entirety of the perimeter is surrounded by portions of the seat 1014. The perimeter of the third intermediate pane 206 is received within a recess 1022 of the seat 1014 such that an entirety of the perimeter is surrounded by portions of the seat 1014. The recess 1022 of the seat 1014 may have a depth DR10, which is different and less that a depth DR7 of the recesses 722 due to the difference in the size of the third intermediate pane 206. The seat 1014 includes an elongated body that has a substantially rectangular cross-section. However, other cross-sectional shapes are possible. The seat 1014 may be formed of various compressible materials that promote a secure hold between the seat 1014 and the perimeter of the first outer pane 202, the second outer pane 204 and the third intermediate pane 206 therein. Suitable materials may include, but are not limited to, various natural and synthetic rubber materials, and various compressible polymeric materials. Various methods may be used to produce the seat 1014 including, but not limited to, various extrusion processes.

The seat 1014 is fixed within the shoe 716. The shoe 716 includes an elongated body having the base wall 717 and the pair of oppositely disposed side walls 718 extending from the base wall 717. The base wall 717 and the side walls 718 define therebetween a space that receives the seat 1014. Distal edges of the side walls 718 define an opening to the space. In this example, the side walls 718 are perpendicular to the base wall 717 and parallel to each other to define a cross-section having a partial or truncated rectangular shape.

The shoe 716 may be formed of various rigid or semi-rigid materials such as, but not limited to, various polymeric, metallic, and composite materials. In one embodiment the shoe 716 is formed of polyvinylchloride (PVC). In another embodiment, the shoe 716 is formed of stainless steel. In yet another embodiment, the shoe 716 is formed of aluminum or an alloy thereof. In yet another embodiment, the shoe 716 is formed of a polymer-wood composite. Various methods may be used to produce the shoe 716 including, but not limited to, various extrusion processes.

The pair of couplings are located between the seat 1014 and the shoe 716 that are configured to promote the seal between the seat 1014 and the shoe 716 and thereby substantially seal the chambers defined between the first outer pane 202 and the third intermediate pane 206; and the third intermediate pane 206 and the second outer pane 204. The couplings include ribs or protrusions 720 extending from and along interior sides of the side walls 718 into the space defined by the side walls 718 and the base wall 717 of the shoe 716, and a pair of corresponding grooves or channels 724 in the seat 1014. The protrusions 720 are configured to be received within the channels 724 and function therein as barriers that impede relative movement between the seat 1014 and the shoe 716 in directions parallel to the first outer pane 202, the second outer pane 204 and the third intermediate pane 206. That is, the protrusions 720 contact interior surfaces of the channels 724 and thereby reduce a likelihood that the seat 1014 may move out of the opening of the shoe 716. In one example, the side walls 718 of the shoe 716 as each having a pair of semicircular cross-section protrusions 720 configured to be received within corresponding semicircular channels 724.

The protrusions 720 of the couplings may each include a solid body integral to the shoe 716, a solid body secured to the shoe 716, or a solid body having a coating thereon. The protrusions 720 and/or the coatings thereon may be formed of various materials such as, but not limited to, various polymeric, metallic, and composite materials. In some embodiments, the protrusions 720 include a thermosetting or thermoplastic material. Various methods may be used to produce the protrusions 720 including, but not limited to, various extrusion processes. If the protrusions 720 include coatings thereon, the coatings may be produced with various deposition processes including, but not limited to, physical application processes (e.g., painting) and physical vapor deposition (PVD) processes.

The chambers defined between the first outer pane 202, the second outer pane 204 and the third intermediate pane 206, and sealed about the perimeters thereof with the outer edge sealing spacer arrangement 110, are filled with the fluid F, if desired. The fluid F applies forces on the first outer pane 202, the second outer pane 204 and the third intermediate pane 206 along the interior/exterior axis 22, and on the seat 1014 toward the base wall 717 of the shoe 716 or along the vertical axis 18. These forces expand and/or stretch the seat 1014 in directions toward the side walls 718 and the base wall 717 of the shoe 716. Since the shoe 716 includes a rigid body, a clamping force is effectively applied on the seat 1014 that secures the perimeter of the first outer pane 202, the second outer pane 204 and the third intermediate pane 206 in the recesses 722, 1022 of the seat 1014 and secures the seat 1014 within the shoe 716. Thus, in this example, the multiple pane insulated glazing unit 1000 does not include a sealant material to seal between the respective panes 202, 204, 206. In one example, the multiple pane insulated glazing unit 1000 has a width WG8, which is about 19 millimeters (mm) to about 35 millimeters (mm).

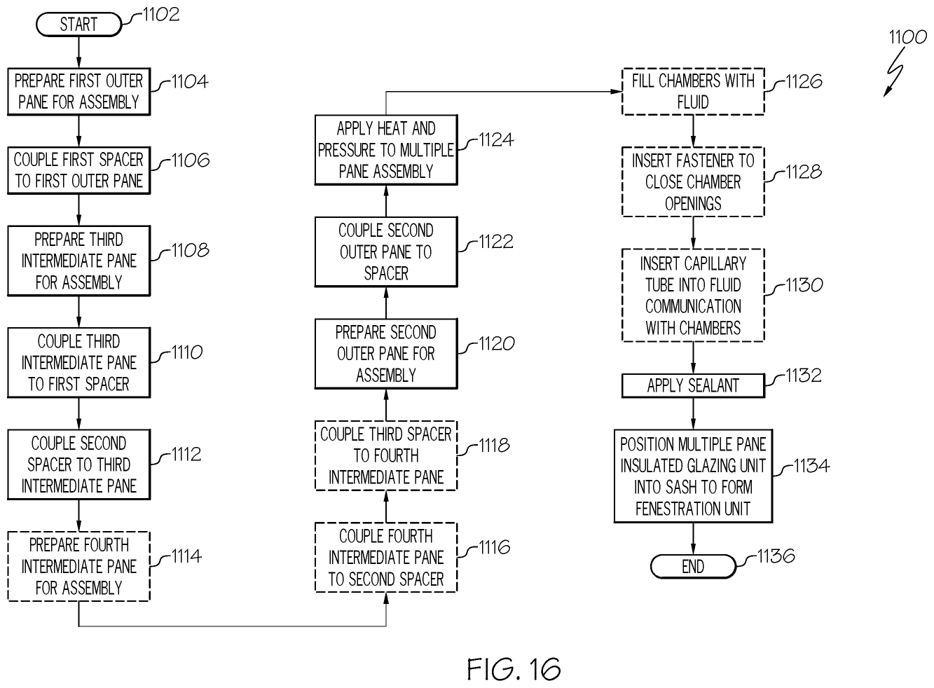

With reference to FIG. 16, and continued reference to FIGS. 1-12, a method 1100 of manufacturing the multiple pane insulated glazing unit 200, 400, 500, 600 is shown. In one example, the method 1100 begins at 1102. At 1104, the first outer pane 202 is prepared. For example, with the first outer pane 202 formed, the first outer surface 220 may be coated with the hard coating, scratch resistant coating or pyrolytic coating via the pyrolytic coating process. The first inner surface 222 may be coated with the low emissivity coating via magnetron sputtering, for example. Alternatively, the first outer surface 220 and/or the first inner surface 222 may be uncoated. The first outer pane 202 is washed to remove any debris and prepare the first outer pane 202 for assembly. At 1106, in one example, with the first spacer 208, 508, formed and shaped into the shape that corresponds with the first outer pane 202, the first sealant 300 is coupled to the first spacer leg 262 of the first spacer 208 or the first surface 538 of the first spacer 508, and the second sealant 302 is coupled to the second spacer leg 264 of the first spacer 208 or the second surface 540 of the first spacer 508. With the first sealant 300 and the second sealant 302 coupled to the first spacer 208, 508, the first spacer 208, 508 is coupled to the first inner surface 222 of the first outer pane 202.

At 1108, the third intermediate pane 206 is prepared for assembly. In one example, with the third intermediate pane 206 formed, the third inner surface 240 may be coated with the hard coating, transparent conductive oxide coating or tin oxide coating via the pyrolytic coating process. The fourth inner surface 242 may be coated with the hard coating via the pyrolytic coating process, for example. Alternatively, the third inner surface 240 and/or the fourth inner surface 242 may be uncoated. The third intermediate pane 206 is washed to remove any debris and prepare the third intermediate pane 206 for assembly. At 1110, the third inner surface 240 of the third intermediate pane 206 is coupled to the first spacer 208, 508. At 1112, in one example, with the second spacer 210, 510, formed and shaped into the shape that corresponds with the first outer pane 202 and the third intermediate pane 206, the first sealant 300 is coupled to the first spacer leg 262 of the second spacer 210 or the first surface 538 of the second spacer 510, and the second sealant 302 is coupled to the second spacer leg 264 of the second spacer 210 or the second surface 540 of the second spacer 510. With the first sealant 300 and the second sealant 302 coupled to the second spacer 210, 510, the second spacer 210, 510 is coupled to the fourth inner surface 242 of the third intermediate pane 206.

Optionally, at 1114, the fourth intermediate pane 402 is prepared for assembly. In one example, with the fourth intermediate pane 402 formed, the fifth inner surface 410 may be coated with the hard coating, transparent conductive oxide coating or tin oxide coating via the pyrolytic coating process. The sixth inner surface 412 may be coated with the hard coating via the pyrolytic coating process, for example. Alternatively, the fifth inner surface 410 and/or the sixth inner surface 412 may be uncoated. The fourth intermediate pane 402 is washed to remove any debris and prepare the fourth intermediate pane 402 for assembly. Optionally, at 1116, the fifth inner surface 410 of the fourth intermediate pane 402 is coupled to the second spacer 210, 510. Optionally, at 1118, in one example, with the third spacer 404, 604, formed and shaped into the shape that corresponds with the first outer pane 202, the third intermediate pane 206 and the fourth intermediate pane 402, the first sealant 300 is coupled to the first spacer leg 262 of the third spacer 404 or the first surface 538 of the third spacer 604, and the second sealant 302 is coupled to the second spacer leg 264 of the third spacer 404 or the second surface 540 of the third spacer 604. With the first sealant 300 and the second sealant 302 coupled to the third spacer 404, 604, the third spacer 404, 604 is coupled to the sixth inner surface 412 of the fourth intermediate pane 402.

At 1120, the second outer pane 204 is prepared. For example, with the second outer pane 204 formed, the second inner surface 232 may be coated with the low emissivity coating via magnetron sputtering, for example. The second outer surface 230 may be coated with the hard coating, transparent conductive oxide coating or tin oxide coating via the pyrolytic coating process, for example. Alternatively, the second inner surface 232 and/or the second outer surface 230 may be uncoated. The second outer pane 204 is washed to remove any debris and prepare the second outer pane 204 for assembly. At 1122, the second inner surface 232 of the second outer pane 204 is coupled to the second spacer 210, 510 or the third spacer 404, 604.

In one example, blocks 1104-1122 are performed horizontally or with the first outer pane 202 positioned with the first outer surface 220 on a roller conveyer, and the first spacer 208, 508, the third intermediate pane 206, the second spacer 210, 510, the optional fourth intermediate pane 402, the third spacer 404, 604 and the second outer pane 204 are assembled together to form a subassembly in a vertical direction. With the subassembly of the first outer pane 202, the third intermediate pane 206, the optional fourth intermediate pane 402, the second outer pane 204 and the respective spacers 208, 210, 404, 508, 510, 604 formed and coupled together as discussed in blocks 1104-1122, at 1124, the subassembly is inserted into an oven press, via sliding the subassembly on the roller conveyer into the oven press, for example. The oven press applies a temperature to the subassembly while substantially simultaneously pressing or applying a pressure to the subassembly. The oven press has a temperature that enables the sealant 300, 302 to reach a predetermined sealant temperature to form a seal, which in one example, is about 150 degrees Fahrenheit (F) to about 180 degrees Fahrenheit (F). The oven press applies a pressure to the subassembly to assist in fixedly coupling the first outer pane 202, the third intermediate pane 206, the optional fourth intermediate pane 402, the second outer pane 204 together via the respective spacers 208, 210, 404, 508, 510, 604 of about 5% to about 15% greater than the predetermined width WG, WG4, WG5, WG6 of the multiple pane insulated glazing unit 200, 400, 500, 600 upon completion of manufacturing and also distributes the sealant 300, 302. This ensures that the multiple pane insulated glazing unit 200, 400, 500, 600 has about the predetermined width WG, WG4, WG5, WG6 after passing through the oven press and that seals are formed by the sealant 300, 302. The temperature of the subassembly may be checked upon exiting the oven press.

At 1126, optionally, the chambers 250, 252, 422, 424 are filled with the fluid F, and at 1128, the mechanical fastener, such as the mechanical fastener 268 is inserted into the fill opening 266 to seal the fill opening 266. Alternatively, or optionally, at 1130, the capillary tube 273 is inserted into the fill opening 266 and placed into fluid communication with the chambers 250, 252, 422, 424 and the chambers 250, 252, 422, 424 are not filled with the fluid. At 1132, a sealant, such as butyl, may be applied over the fill opening 266 or along the respective one of the spacer base 260 of the spacer 208, 210, 404 or the third sidewall 534 of the spacer 508, 510, 604 to complete the assembly of the multiple pane insulated glazing unit 200, 400, 500, 600. At 1134, with the multiple pane insulated glazing unit 200, 400, 500, 600 formed, the multiple pane insulated glazing unit 200, 400, 500, 600 may be inserted into the fenestration frame 12 and retained with the respective glass stops 36. The method 1100 ends at 1136. By assembling the multiple pane insulated glazing unit 200, 400, 500, 600 horizontally, the coatings may be applied during the assembly of the multiple pane insulated glazing unit 200, 400, 500, 600, if desired.

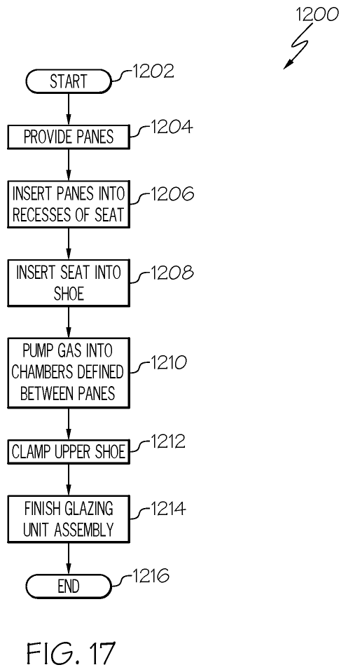

With reference to FIG. 17, and continued reference to FIGS. 13A-15B, a method 1200 of manufacturing the multiple pane insulated glazing unit 800, 900, 1000 is shown. In one example, the method 1200 begins at 1202. The first outer pane 202, the second outer pane 204 and the third intermediate pane 206 may be produced or provided at 1204. At 1206, the method includes receiving the perimeter of the first outer pane 202, the second outer pane 204 and the third intermediate pane 206 into the recesses 522, 822, 622, 922, 722, 1022 of the seat 814, 914, 1014 such that the third intermediate pane 206 is positioned between the first outer pane 202 and the second outer pane 204, and the seat 814, 914, 1014 extends along the perimeter of each of the first outer pane 202, the second outer pane 204 and the third intermediate pane 206. At 1208, the method includes receiving the seat 814, 914, 1014 in the respective shoe 516, 616, 716. In one example, the method includes securing the seat 814, 914, 1014 in the respective shoe 516, 616, 716 with the coupling between the seat 114 and the shoe 116 to define the outer edge sealing spacer arrangement 110 that substantially seals and maintains the inter-pane space between the pair of panes 112. For example, the method may include receiving the seat 814, 914, 1014 into the space defined by the distal edges of the side walls 518, 618, 718. The method may include securing the seat 814, 914, 1014 in the shoe 516, 616, 716 by locating the protrusions 520, 620, 720 extending from the shoe 116 in the channels 524, 624, 724 in the seat 814, 914, 1014.

In various embodiments, at 1210, the method may include filling the chambers defined between the first outer pane 202, the second outer pane 204 and the third intermediate pane 206 with the fluid F to apply a pressure on the seat 814, 914, 1014 sufficient to expand the seat 814, 914, 1014 and thereby promote an integrity of the seal of the chambers defined between the first outer pane 202 and the third intermediate pane 206; and the third intermediate pane 206 and the second outer pane 204. At 1212, the method includes clamping the upper shoe 516, 616, 716. Once the upper shoe 516, 616, 716 is clamped onto the assembly, the force of gravity maintains the multiple pane insulated glazing unit 800, 900, 1000 gas tight. At 1214, the method includes finishing the multiple pane insulated glazing unit 800, 900, 1000. At 1214, the finished multiple pane insulated glazing unit 800, 900, 1000 is generally quality checked and transported to an assembly line to finish the fenestration unit 10. The method ends at 1216. Thus, the method does not include using a sealant material on the outer edges of the shoes 516, 616, 716, the panes 202, 204, 206, or any other component of the multiple pane insulated glazing unit 800, 900, 1000 to seal the chambers defined between the panes 202, 206, 204.

Thus, the multiple pane insulated glazing unit 200, 400, 500, 600, 800, 900, 1000 provides for increased thermal efficiency to be associated with the fenestration unit 10 as the third intermediate pane 206 and optional fourth intermediate pane 402 assist in reflecting thermal energy back into the interior of the building. By providing the multiple pane insulated glazing unit 200, 400, 500, 600, 800, 900, 1000 with the third intermediate pane 206 and optional fourth intermediate pane 402, a thermal efficiency of the fenestration unit 10 with the chambers 250, 250, 422, 424 filled with argon is about 30% greater than a thermal efficiency associated with a one low-emissivity argon gas-filled dual pane insulated glazing unit and 44% greater than a thermal efficiency associated with a two low-emissivity argon gas-filled dual pane insulated glazing unit. Further, the chambers 250, 252, 422, 424, which are each fluidly isolated from each other, provide additional insulation for the respective multiple pane insulated glazing unit 200, 400, 500, 600, 800, 900, 1000. The width WG, WG4, WG5, WG6, WG7 of the multiple pane insulated glazing unit 200, 400, 500, 600, 800, 900, 1000 upon completion of manufacturing is sized such that the multiple pane insulated glazing unit 200, 400, 500, 600, 800, 900, 1000 may be retrofit into existing fenestration frames 12, which enables consumers to improve the energy efficiency of their building or other structure without removing the existing fenestration frame 12. This enables a consumer to replace an existing glazing unit with the multiple pane insulated glazing unit 200, 400, 500, 600, 800, 900, 1000 to achieve better thermal performance without requiring modifications to the existing fenestration frame 12. In addition, a weight of the multiple pane insulated glazing unit 200, 400, 500, 600 is increased by just a few ounces over a two pane insulated glazing unit due to the size of the third intermediate pane 206 and optional fourth intermediate pane 402. The multiple pane insulated glazing unit 200, 400, 500, 600, 800, 900, 1000 may be configured to have a reduced profile and may have a compact width WG, WG4, WG5, WG6, WG7 considering the at least three panes included therein. Thus, the multiple pane insulated glazing unit 200, 400, 500, 600, 800, 900, 1000 may provide the described thermal benefits and other benefits while also maintaining a low-profile overall width.

It should be noted that in certain embodiments, the perimeter of one or more of the panes 202, 204, 206, 402 may be modified to assist in coupling the sealant 300, 302 to the respective pane 202, 204, 206, 402. For example, the perimeter may be enameled to enable the sealant 300, 302 to adhere to the respective one of the panes 202, 204, 206, 402. In addition, the perimeter may be etched or machined to provide a coating free surface for adherence to the sealant 300, 302.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A multiple pane insulated glazing unit for a fenestration unit, comprising:
a first outer pane including a first outer surface opposite a first inner surface, and the first outer pane having a first thickness defined between the first outer surface and the first inner surface;
a first spacer coupled to the first inner surface;
a second outer pane including a second outer surface opposite a second inner surface, and the second outer pane has a second thickness defined between the second outer surface and the second inner surface;
a spacer coupled to the second inner surface; and
an intermediate pane coupled to at least one of the first spacer and the spacer so as to be disposed between the first outer pane and the second outer pane, the intermediate pane including a third inner surface opposite a fourth inner surface, the intermediate pane has a third thickness defined between the third inner surface and the fourth inner surface that is less than the first thickness and the second thickness, the third thickness is between about 0.2 millimeters (mm) to about 1.2 millimeters (mm), and the first outer pane, the second outer pane and the intermediate pane are composed of boron-free soda lime silicate glass.

2. The multiple pane insulated glazing unit of claim 1, wherein the first thickness and the second thickness are about the same.

3. The multiple pane insulated glazing unit of claim 1, wherein the intermediate pane comprises a single intermediate pane having the third inner surface and the fourth inner surface, the third inner surface is coupled to the first spacer and the fourth inner surface is coupled to the spacer.

4. The multiple pane insulated glazing unit of claim 3, wherein a first chamber is defined between the first inner surface and the third inner surface, a second chamber is defined between the fourth inner surface and the second inner surface, the first spacer encloses the first chamber, and the spacer encloses the second chamber.

5. The multiple pane insulated glazing unit of claim 4, wherein the first chamber is fluidly isolated from the second chamber.

6. The multiple pane insulated glazing unit of claim 1, wherein the intermediate pane comprises a first intermediate pane and a second intermediate pane, the first intermediate pane having the third inner surface and the fourth inner surface, the second intermediate pane having a fifth inner surface and a sixth inner surface, the third inner surface is coupled to the first spacer and the fourth inner surface is coupled to a third spacer, the fifth inner surface is coupled to the third spacer and the sixth inner surface is coupled to the spacer.

7. The multiple pane insulated glazing unit of claim 1, wherein the first spacer and the spacer are each composed of a metal or a metal alloy.

8. The multiple pane insulated glazing unit of claim 7, wherein each of the first spacer and the spacer include a spacer base, a first spacer leg and a second spacer leg, the first spacer leg and the second spacer leg extend upwardly from opposed sides of the spacer base, the first spacer leg and the second spacer leg are spaced apart from each other to define a slot, and the first spacer and the spacer are sized to extend about a perimeter of the intermediate pane.

9. The multiple pane insulated glazing unit of claim 8, wherein a fill opening is defined in the spacer base and is fluidly coupled to a respective one of a first chamber defined between the first outer pane and the intermediate pane and a second chamber defined between the intermediate pane and the second outer pane.

10. The multiple pane insulated glazing unit of claim 8, wherein a first sealant is coupled to the first spacer leg and a second sealant is coupled to the second spacer leg.

11. The multiple pane insulated glazing unit of claim 10, wherein the first sealant and the second sealant are the same.

12. The multiple pane insulated glazing unit of claim 1, wherein the first spacer and the spacer are each composed of a polymer based material.

13. The multiple pane insulated glazing unit of claim 1, wherein the third inner surface includes a tin oxide coating.

14. The multiple pane insulated glazing unit of claim 1, wherein the first outer surface and the second outer surface include a scratch resistant coating.

15. The multiple pane insulated glazing unit of claim 1, wherein at least one of the first inner surface and the second inner surface includes a low emissivity coating.

16. The multiple pane insulated glazing unit of claim 1, wherein a perimeter of the intermediate pane is less than a perimeter of each of the first outer pane and the second outer pane.

17. A method of manufacturing a multiple pane insulated glazing unit, comprising:
providing a first outer pane including a first outer surface opposite a first inner surface, the first outer pane has a first thickness defined between the first outer surface and the first inner surface;
coupling a first spacer the first inner surface with a first sealant, the first spacer including a second sealant opposite the first sealant;
coupling a third inner surface of an intermediate pane to the first spacer with the second sealant, the intermediate pane including a fourth inner surface opposite the third inner surface, the intermediate pane has a third thickness defined between the third inner surface and the fourth inner surface that is less than the first thickness, and the third thickness is between about 0.2 millimeters (mm) to about 1.2 millimeters (mm);
coupling a spacer to the fourth inner surface with the first sealant, the spacer including the first sealant opposite the second sealant; and
coupling a second inner surface of a second outer pane to the spacer with the second sealant to form a subassembly, the second outer pane including a second outer surface opposite the second inner surface, and the second outer pane has a second thickness defined between the second outer surface and the second inner surface that is the same as the first thickness.

18. The method of claim 17, further comprising:
heating the subassembly at a predetermined temperature to form a seal with the first sealant and the second sealant while substantially simultaneously pressing the subassembly to a predetermined width for the multiple pane insulated glazing unit.

19. The method of claim 17, further comprising:
applying a coating to at least one of the first outer surface, the first inner surface, the third inner surface, the fourth inner surface, the second inner surface and the second outer surface.

20. The method of claim 17, further comprising:
filling a first chamber defined between the first outer pane and the intermediate pane with a fluid through a fill opening defined through the first spacer; and
sealing the fill opening.
